(19) United States
(12) Patent Application Publication
(10) Pub. No.: US 2021/0003176 A1
(43) Pub. Date: Jan. 7, 2021

(54) JOINT DEVICE

(71) Applicant: Süddeutsche Gelenkscheibenfabrik GmbH & Co. KG, Waldkraiburg (DE)

(72) Inventors: Armin Huber, Schönberg (DE); Wolfgang Orthofer, Jr., Mühldorf a. Inn (DE)

(73) Assignee: Süddeutsche Gelenkscheibenfabrik GmbH & Co. KG, Waldkraiburg (DE)

(21) Appl. No.: 16/919,597

(22) Filed: Jul. 2, 2020

(30) Foreign Application Priority Data
Jul. 2, 2019 (DE) 10 2019 004 644.7

(51) Int. Cl. F16D 3/70; F16D 3/12

(52) U.S. Cl. CPC F16D 3/70; F16D 3/12; F16D 2300/22; F16D 2200/006; F16D 2200/0056

(57) ABSTRACT

A joint device is provided for connecting two shaft sections. The joint device comprises at least one joint, at least one elastic damping arrangement which provides mechanical decoupling of the at least one joint and is coupled to the at least one joint in a torque transmitting manner, the elastic damping arrangement having at least one fiber package which is at least partially embedded in an elastic material, the at least one damping arrangement being arranged with the at least one joint in such a manner that at least the at least one joint and the at least one damping arrangement are arranged coincident at least in the rest state of the joint device.

### BACKGROUND OF THE INVENTION

The present invention relates to a joint device for the torque transmitting connection between two shaft sections.

### BRIEF SUMMARY OF THE INVENTION

It is an object of the present invention to specify a joint device which allows high articulation angles, takes up little installation space in the radial direction and at the same time has an improved service life.

This object is achieved by a joint device for connecting two shaft sections, having the features at least one joint; and at least one elastic damping arrangement which provides mechanical decoupling of the at least one joint and is coupled to the at least one joint in a torque transmitting manner, the elastic damping arrangement comprising at least one fiber package which is at least partially embedded in an elastic material, the at least one damping arrangement being coupled to the at least one joint in such a manner that at least the at least one joint and the at least one damping arrangement are arranged coincident at least in the rest state of the joint device.

In other embodiments, the joint device has at least two devices at at least two positions offset in the axial direction which are designed to couple the at least one joint and the at least one damping arrangement. In another embodiment, the at least one damping arrangement has at least one damper part which has one or more fiber packages. In another embodiment, the at least one damper part has a plurality of coupling portions in each of which at least one fiber package is provided, wherein the coupling portions are connected to each other via at least one connecting portion. In another embodiment, the coupling portions have a plurality of fiber packages which extend at least substantially parallel and/or obliquely to each other. In another embodiment, the at least one damper part has a plurality of bushings, each of which is surrounded by two fiber packages. In another embodiment, the at least one damping arrangement has a plurality of elastic coupling elements, each of the coupling elements having at least one fiber package. In another embodiment, the at least one joint has at least two joint forks, the at least two joint forks being coupled to each other in a torque transmitting manner via the at least one damping arrangement. In another embodiment, each of the joint forks has at least two bearing elements, in each of which at least one bearing for mounting the joint forks is accommodated. In another embodiment, the bearing elements assigned to one of the joint forks are connected to each other via at least one bracket. In another embodiment, the brackets are coupled to each other so as to be rotatable relative to each other. In another embodiment, each of the bearing elements has at least one device which is designed to couple the at least one damping arrangement to the at least one joint. In another embodiment, the at least one device is at least one opening in one of the bearing elements and/or at least one projection at one of the bearing elements. In another embodiment, the at least one joint device has at least one coupling flange which couples the at least one damping arrangement to the at least one joint. In another embodiment, the at least one damping arrangement establishes a torque transmitting connection between the at least one coupling flange and at least one further flange. In another embodiment, at least the at least one coupling flange has at least two axial fastening surfaces which are offset from each other in the axial direction, wherein the at least two axial fastening surfaces being designed for coupling with the at least one damping arrangement. In another embodiment, at least one damper part of the at least one damping arrangement is arranged on each of the two axial fastening surfaces. In another embodiment, the at least one joint is a constant velocity joint. In another embodiment, the at least one joint device has at least one centering device which is arranged coincident with the at least one joint and the at least one damping arrangement. In another embodiment, the joint device is designed to provide a limit stop function. In yet another embodiment, each bearing element has at least one limit stop.

In another embodiment, a damper part for a joint device according to the foregoing embodiments of the invention is provided. According to the invention, the damper part has at least one coupling portion and at least one connecting portion, wherein in the at least one coupling portion at least one fiber package is provided which runs around two openings, and the at least one connecting portion is free of fiber reinforcement.

According to the invention, the joint device for connecting two shaft sections comprises at least one joint and at least one elastic damping arrangement, which provides mechanical decoupling of the at least one joint and is coupled to the at least one joint in a torque transmitting manner. The at least one damping arrangement has at least one fiber package which is at least partially embedded in an elastic material, the at least one damping arrangement being coupled to the at least one joint in such a manner that at least the at least one joint and the at least one damping arrangement are arranged coincident at least in the rest position of the joint device.

The joint device according to the invention can allow high articulation angles and at the same time mechanically decouple the two shaft sections which must be connected via the joint device, such that no or almost no oscillations and/or vibrations can be transmitted via the at least one joint device. At least one joint and the at least one damping arrangement are arranged coincident according to the invention, at least in the rest position of the joint device, i.e., the pivot points of the at least one damping arrangement and the at least one joint coincide at a single point. Because of the coinciding arrangement of the at least one damping arrangement and the at least one joint, no bending moments act on the at least one damping arrangement. As a result, the service life of the damping arrangement and the joint device can be improved. The coinciding arrangement of the at least one joint and the at least one damping arrangement can also be maintained during operation and/or in different operating states of the joint device. Due to the coinciding arrangement of the at least one damping arrangement and the at least one joint, the at least one damping arrangement cannot be deformed by an articulation angle, since the at least one joint assumes the articulation angle.

The at least one damping arrangement can provide mechanical decoupling in the torsional direction and/or the axial direction and/or the radial direction. The stiffnesses of the at least one damping arrangement in the torsional, axial or radial direction can be adjusted as a function of the given field of application of the joint device. The joint device can be used, for example, in industrial applications, and in vehicles in drive and steering applications. Mechanical decoupling is to be understood here as a vibration decoupling by means of the damping arrangement between the parts or elements coupled to the damping arrangement.

At least in each of two positions which are offset in the axial direction from each other, the joint device can have at least one device which is designed to couple the at least one joint and the at least one damping arrangement. These devices can be formed, for example, by openings, projections or similar elements on the joint device.

The at least one fiber package can have strands running parallel to each other at least in sections. The strands of the at least one fiber package run parallel to each other in particular in a portion which is located between two openings around which the at least one fiber package is wound. The strands of the fiber package do not cross and can be spaced apart from each other. The at least one fiber package can be at least partially embedded in an elastic sheath or an elastic body. The at least one fiber package can be formed by a single thread which is wound like a strap or by a plurality of threads which are wound like a strap. The elastic body or the elastic sheath can for example be made of an elastomer, a thermoplastic elastomer, a polymer or rubber.

The at least one damping arrangement can have at least one damper part which has a plurality of fiber packages. The at least one damper part can have coupling portions, in each of which at least one fiber package is provided. The coupling portions can be connected to each other via at least one connecting portion. The coupling portions can have at least one opening. The at least one opening can extend in the radial direction through the respective coupling portion. The at least one damper part can be annular. The at least one damper part can be designed as a closed ring. The at least one connecting portion can be free of thread reinforcement. The at least one connecting portion can serve the purpose of connecting adjacent coupling portions. The at least one damper part can generate a fastening force acting radially inward which holds the at least one damper part on the joint device.

The coupling portions can have a plurality of fiber packages. The fiber packages can extend at least substantially parallel and/or obliquely to each other. The fiber packages can cross. Furthermore, the fiber packages can also overlap at least in sections or can be arranged one above the other.

The at least one damper part can have a plurality of bushings. Each of the bushings can be wound by at least two fiber packages. The bushings can be designed in the form of a coil. The bushings can have a tubular portion, at the ends of which radial portions extend outwards. The at least one damper part can be supported on connected elements or components via the radial portions of the bushings. Screws can extend through the bushings in order to fasten the at least one damper part to the joint device.

The fiber packages winding around one of the bushings can have cross-sections of different sizes. The cross-sections can be rectangular and/or differ in size. The size of the cross-section of the respective fiber package can depend on the use of the fiber package in a tensile path or a compression path.

The at least one damping arrangement can have a plurality of elastic coupling elements. Each of the coupling elements can have at least one fiber package. A first group of the coupling elements can be arranged on the joint at a first axial position and a second group of the coupling elements can be arranged at a second axial position. Each group can have a plurality of coupling elements which extend parallel to each other. Accordingly, multiple levels with coupling elements can be provided at each axial position. This allows the axial stiffness of the damping arrangement to be adjusted. The at least one joint can have at least two joint forks. The at least two joint forks can be coupled to each other in a torque transmitting manner via the at least one damping arrangement. The at least two joint forks can be rotated relative to each other, with elastic deformation of the at least one damping arrangement. Since the at least one damping arrangement can establish the torque transmitting connection between the two joint forks, the at least one damping arrangement can mechanically decouple the two joint forks from each other, so that no oscillations and/or vibrations are transmitted between the two joint forks.

Each of the joint forks can have at least two bearing elements. At least one bearing for mounting the joint forks can be accommodated in each of the bearing elements. The bearing elements can accommodate at least portions of pivot pins formed on the joint forks. The pivot pins of the joint forks can extend outwards or inwards in the radial direction. The pivot pins are provided on the fork arms of the joint forks. In particular, the pivot pins can extend radially outwards or inwards, starting from the fork arms. The bearings for mounting the joint forks can have, for example, a needle bearing. Furthermore, the bearings for mounting the joint forks can also have at least one axial plain bearing. The bearings can also have a needle bearing and an axial plain bearing and thus form a bearing unit for mounting the pivot pins of the joint forks.

The joint forks can be arranged radially inside or radially outside of the damping arrangement. The joint forks can surround the damping arrangement at least in sections in the radial direction.

The bearing elements assigned to the joint forks can be connected to each other via at least one bracket. The brackets can be integrally formed with the bearing elements. The brackets can be coupled to each other so that they can rotate relative to each other. The brackets can extend between the joint arms of the joint fork to which they are not coupled via the bearing elements. The bearing elements can have at least one axial fastening surface. The bearing elements can have at least two opposing fastening surfaces. The bearing elements can have at least one fastening surface which substantially extends at an angle of 90° to the axial fastening surfaces. The coupling elements can be attached to the fastening surfaces. In particular, the coupling elements can be attached to the fastening surfaces of the bearing elements by means of bolts. The bolts can extend into the bearing elements in the radial or axial direction.

The joint device can also have a failsafe running function. The failsafe running function can be provided by the bearing elements and the brackets. If the damping arrangement is damaged or destroyed, such that the joint forks are no longer coupled to transmit torque, the brackets prevent the two joint forks from being separated from each other or from being able to fall apart. The brackets can thus maintain a coupling of the joint forks. In this state, two adjacent bearing elements can come into abutment against each other and create a positive connection. Torque can still be transmitted via the joint through this positive connection. Among other things, this can be relevant for the use of the joint device in the steering of a vehicle, since the steering of a vehicle is a safety component and emergency operation must be ensured. With the joint device, further safety measures for providing a failsafe running function can be omitted.

The joint device can have a limit stop function. The limit stop function can act in particular in a torsional direction. The bearing elements of the joint device can each have at least one limit stop. The limit stop can be formed integrally on the respective bearing element. The at least one limit stop can be formed by a projection. Each bearing element can have at least two limit stops or limit stop projections. The limit stops on a bearing element can extend in opposite directions. The at least one limit stop can have at least one limit stop surface. The limit stop function can contribute to providing the failsafe running function described above.

Each of the bearing elements can have at least one device which is designed to couple the at least one damping arrangement to the at least one joint. The at least one device can be at least one opening in one of the bearing elements and/or at least one projection on one of the bearing elements. The at least one opening can extend, for example, in the axial direction through one of the bearing elements. A fastening element, with which the damping arrangement can be fastened to the bearing element, can extend through the at least one opening. The damping arrangement can, for example, be attached to an axial fastening surface of the bearing elements. However, it is also conceivable to provide openings in the radial direction on the bearing elements in order to enable attaching the at least one damping arrangement on the bearing elements. Furthermore, projections can be provided on the bearing elements in the axial direction or radial direction, which can be coupled to the at least one damping arrangement. The projections can be pin-shaped or bolt-shaped. The projections may have an enlarged end to hold the damping assembly on the projections.

The at least one joint device can have at least one coupling flange which couples the at least one damping arrangement to the at least one joint. The at least one coupling flange can have a plurality of flange arms extending in the radial direction. Axial fastening surfaces can be formed on the flange arms, which are provided for connection to the at least one damping arrangement. The at least one joint can be arranged radially within the coupling flange. The at least one damping arrangement can establish a torque transmitting connection between the at least one coupling flange and at least one further flange. The at least one further flange can have flange arms extending in the radial direction. The flange arms of the coupling flange and the flange arms of the further flange can be arranged and designed such that they can engage in each other in the circumferential direction. As a result, the failsafe running function described above can also be provided by the coupling flange and the further flange.

At least the at least one coupling flange can have at least two axial fastening surfaces which are offset from each other in the axial direction. The at least two axial fastening surfaces can be designed for coupling to the at least one damping arrangement. The axial fastening surfaces can be provided on enlarged head portions of the flange arms. The axial fastening surfaces can extend parallel to each other at least in sections. The head portions can have an enlarged extension, in particular in the axial direction. The fastening surfaces can be opposite to each other. At least one damper part of the damping arrangement can be attached to each of the fastening surfaces, such that the damper parts are coupled to the at least one joint at different positions in the axial direction.

The at least one further flange can likewise be equipped with axial fastening surfaces. The axial fastening surfaces of the further flange can also be formed on an enlarged head portion of the flange arms of the further flange. At least one damper part of the at least one damping arrangement can be arranged on each of the two axial fastening surfaces

The at least one joint can be a constant velocity joint. The constant velocity joint can be, for example, a fixed ball joint, a sliding ball joint or a tripod joint.

The at least one joint device can have at least one centering device. The at least one centering device can be arranged at least in the rest position of the joint device coincident with the at least one joint and the at least one damping arrangement—i.e., the pivot points of the at least one damping arrangement, the at least one centering device and the at least one joint coincide at one point. The at least one centering device can have at least one centering pin and at least one centering sleeve. The centering sleeve can have an elastic layer. The elastic layer can accommodate the centering pin at least in sections. The elastic layer can also have a bushing in which the centering pin is received at least in sections. The at least one centering device can couple the aforementioned brackets to each other such that they can rotate relative to each other. In this case, the centering device can comprise the axis of rotation about which the brackets can be rotated relative to each other. The at least one further flange can comprise the at least one centering pin. The centering sleeve can be connected to the coupling flange via a centering part. The at least one centering device can act as a plain bearing. The at least one centering device can absorb or compensate for deflections of the joint forks in the axial direction with elastic deformation of the damping device.

The present invention further relates to a damper part for a joint device.

The damper part has at least one coupling portion and at least one connecting portion, wherein in the at least one coupling portion at least one fiber package is provided, which runs around two openings, and wherein the at least one connecting portion is free of thread reinforcement. The at least one damper part can be annular.

### BRIEF DESCRIPTION OF THE SEVERAL VIEWS OF THE DRAWING

Exemplary embodiments of the invention are described below with reference to the attached figures, wherein:

FIGS. 1 to 6 are different views of a joint device according to a first embodiment;

FIGS. 7 to 9 are different views of a joint device according to a second embodiment of the invention;

FIGS. 10 to 16 are different views of a joint device according to a third embodiment of the invention;

FIGS. 17 to 20 are different views of a joint device according to a fourth embodiment of the invention;

FIGS. 21 to 26 are different views of a joint device according to a fifth embodiment; and

FIGS. 27 to 40 are views of further embodiments of a joint device.

### DETAILED DESCRIPTION OF THE INVENTION

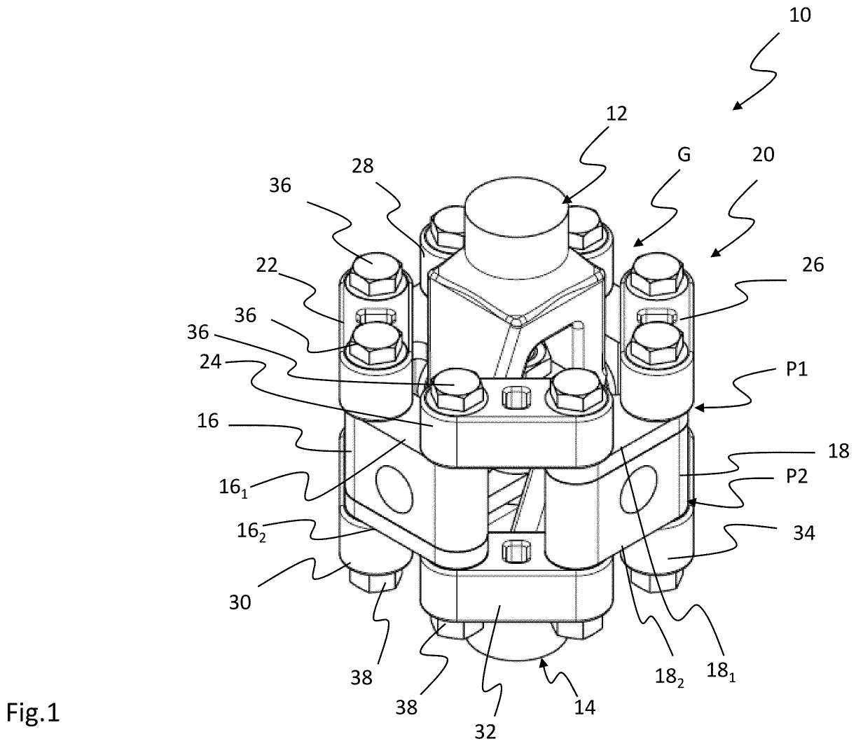

FIG. 1 shows a perspective view of a joint device 10 according to a first embodiment. The joint device 10 comprises a joint G. The joint G has two joint forks 12 and 14. Four bearing elements 16 and 18 are provided on the joint forks 12 and 14, only the bearing elements 16 and 18 being shown in FIG. 1.

The joint device 10 also has a damping arrangement 20. The damping arrangement 20 is formed by a plurality of elastic coupling elements 22, 24, 26, 28, 30, 32, 34. The elastic coupling elements 22, 24, 26, 28, 30, 32, 34 are designed like straps and each have at least one fiber package, not shown in FIG. 1. A first group of coupling elements 22, 24, 26 and 28 is connected to bearing elements 16 and 18 at an axial position P1. A second group of coupling elements 30, 32 and 34 is connected to bearing elements 16 and 18 at a position P2. Positions P1 and P2 are offset from each other in the axial direction. The first group of coupling elements 22, 24, 26, 28 and the second group of coupling elements 30, 32 and 34 are thus connected to bearing elements 16 and 18 at positions P1 and P2 which are offset in the axial direction. The positions P1 and P2 are at a predetermined axial distance from each other. The elastic coupling elements 22, 24, 26 and 28 contact an axial fastening surface 16₁ and 18₁ of the bearing elements 16 and 18. The coupling elements 30, 32 and 34 each abut an axial fastening surface 16₂ and 18₂ of the bearing elements 16 and 18, which is opposite to the first-mentioned fastening surface 16₁ and 18₁. The elastic coupling elements 22, 24, 26, 28, 30, 32 and 34 are connected to the bearing elements 16 and 18 by bolts 36. Each of the bolts 36 extends through two of the elastic coupling elements 22, 24, 26, 28, 30, 32, 34 and one bearing element 16, 18. For example, the bolt 36 extends through the elastic element 24, the bearing element 16 and the elastic element 32, the coupling elements 24 and 32 being arranged on opposite axial fastening surfaces 16₁ and 16₂ of the bearing element 16. Nuts 38 are provided on the bolts 36 and hold the elastic coupling elements 22, 24, 26, 28, 30, 32, 34 on the bearing elements 16 and 18.

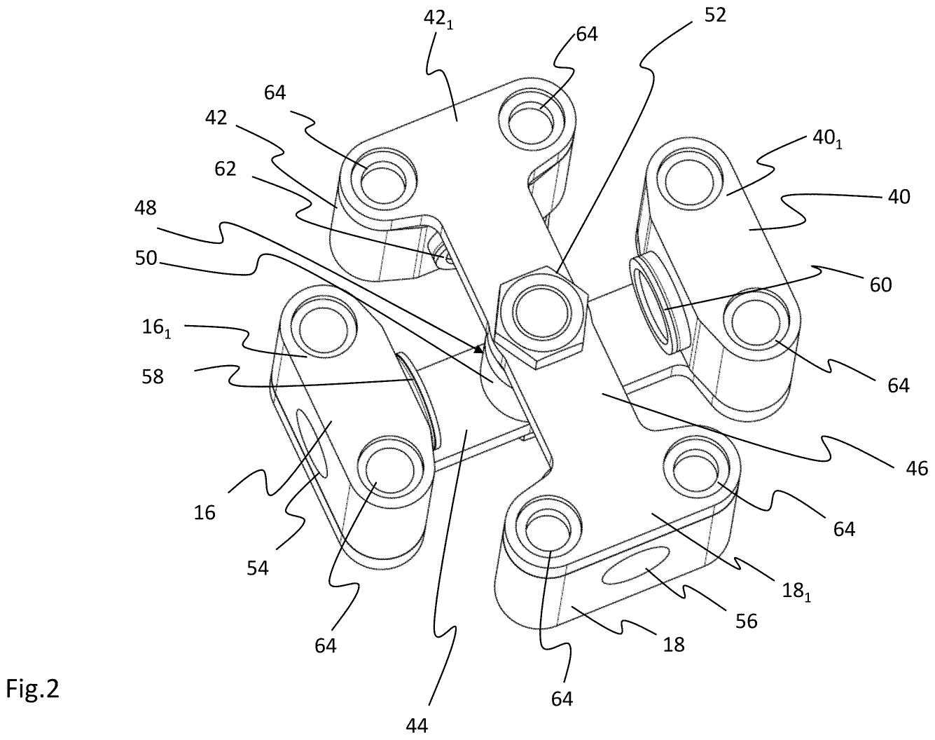

FIG. 2 shows a perspective view of the bearing elements 16, 18, 40, 42. The bearing elements 16 and 40 are connected to each other via a bracket 44. The bearing elements 18 and 42 are connected to each other via a bracket 46. The brackets 44 and 46 are coupled to each other in the axial direction by a centering device 48. The centering device 48 couples the brackets 44 and 46 to each other in a manner enabling relative rotation and relative axial displacement. The brackets 44 and 46 and thus also the bearing elements 14, 16, 40, 42 connected to each other via these brackets 44, 46 can be rotated relative to each other about a pivot point formed by the centering device 48, and are axially displaceable. Only one centering sleeve 50 of the centering device 48 is shown in FIG. 2. The centering device 48 sets a predetermined axial distance between the brackets 44, 46. The predetermined distance is matched to the axial height of the bearing elements 16, 18, 40 and 42. The centering device 48 is connected to the brackets 44 and 46 via the nut 52. The bearing elements 16, 18, 40, 42 have openings 54, 56. Bearings 58, 60, 62 are accommodated in the openings 54, 56 of the bearing elements 16, 18, 40, 42 and are used to mount the pivot pins (not shown) of the joint forks 12 and 14 on the bearing elements 16, 18, 40, 42.

The bearing elements 14, 16, 40, 42 each have two openings 64 through which the bolts 36 (see FIG. 1) extend when the joint device 10 is assembled. Of the eight coupling elements present, only the seven coupling elements 22, 24, 26, 28, 30, 32, 34 are shown or recognizable in FIG. 1. The axial fastening surfaces 16₁, 18₁, 40₁, 42₁ for fastening the elastic coupling elements 22, 24, 26, 28, 30, 32, 34 are either formed directly on the bearing elements 16 and 40 or on the bracket 46 which connects the bearing elements 18 and 42 to each other. The same applies to the bracket 44. The bracket 44 and 46 thus extend along an axial surface of the bearing elements 16, 18, 40, 42. The openings 64 extend in the axial direction through the bearing elements 14, 16, 40, 42 and the brackets 44, 46.

The joint device 10 is further designed to provide a failsafe running function. This failsafe running function is provided by the bearing elements 16, 18, 40, 42 and the brackets 44 and 46 connected to each other via the centering device 48. Should one or more of the elastic coupling elements 22, 24, 26, 28, 30, 32, 34 (see FIG. 1) be damaged or destroyed, the two joint forks 12 and 14 are still coupled together via the bearing elements 16, 18, 40, 42 and bracket 44 and 46. In this state, two adjacent bearing elements 16, 18, 40, 42 can come into abutment and establish a positive connection. Torque can still be transmitted by this positive connection. For example, in FIG. 2, the bearing elements 16, 18 and the bearing elements 40 and 42 can come into abutment and produce a positive connection. The two joint forks 12 and 14 (see FIG. 1) are then still coupled to each other in a torque transmitting manner in this state. This is particularly relevant for use in the steering of a vehicle, since the steering of a vehicle is a safety component and a failsafe running function and/or an emergency operation must be ensured.

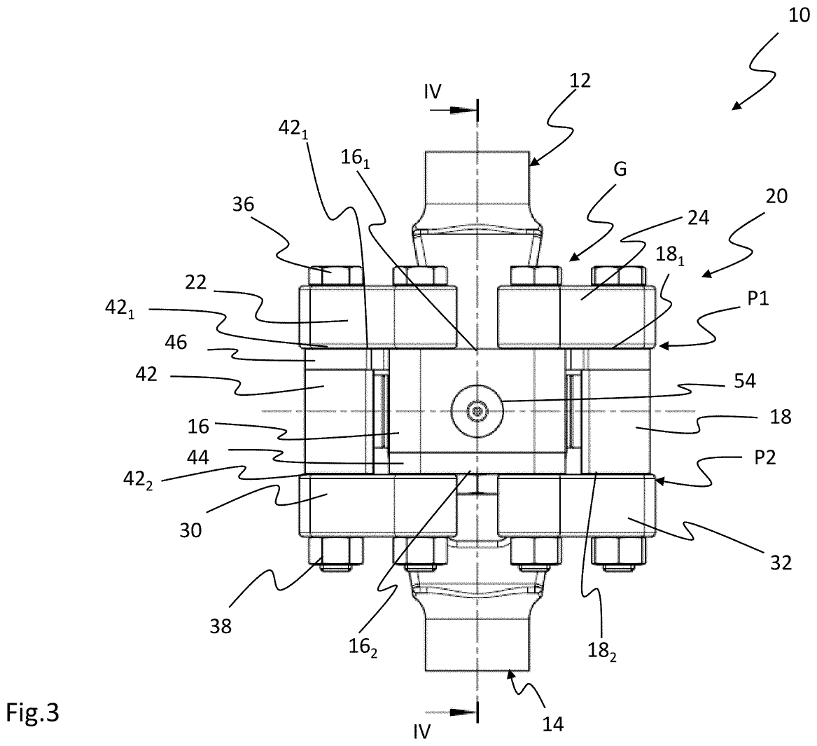

FIG. 3 shows a side view of the joint device 10. FIG. 3 shows the joint forks 12 and 14, the bearing elements 16, 18, 42 and the damping arrangement 20. The elastic coupling elements 22, 24, 30, 32 are connected to the bearing elements 16, 18, 42 at positions P1 and P2, said positions being offset in the axial direction. The elastic coupling elements 22, 24, 30, 32 rest on axial surfaces of the bearing elements 16, 18, 42 or the brackets 44, 46. The bolts 36 extend through two elastic coupling elements 22, 24, 30, 32, through one bearing element 16, 18, 42 and through one of the brackets 44, 46 in each case. The heads of the bolts 36 and the nuts 38 rest on axial surfaces of the elastic coupling elements 22, 24, 30, 32. In the bearing element 16, the opening 54 can be seen in which a bearing for mounting a pivot pin (not shown) of the joint fork 12 is accommodated.

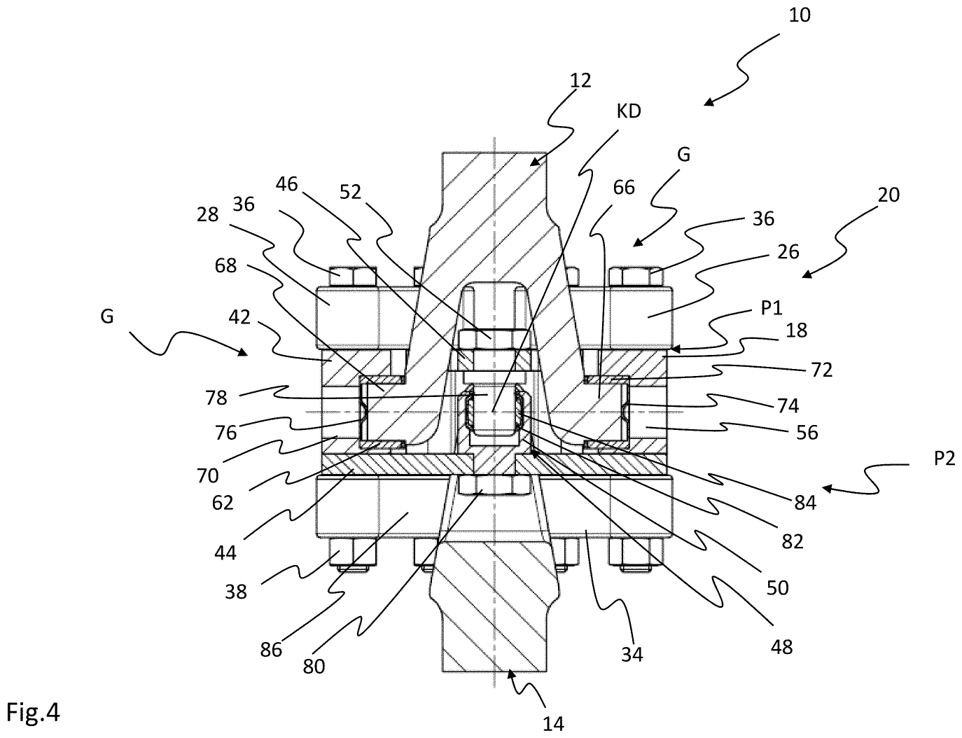

FIG. 4 shows a sectional view along the section line Iv-Iv in FIG. 3. The joint fork 12 has pivot pins 66 and 68, which are received in sections in the openings 56 and 70 of the bearing elements 18 and 42. The pivot pins 66 and 68 extend outward in the radial direction. The pivot pins 66 and 68 are mounted in the openings 56, 70 via bearings 62 and 72. The bearings 62 and 72 may be needle bearings. The openings 56 and 70 in the bearing elements 18 and 42 are stepped, so that the bearings 62 and 72 can be supported on the steps of the openings 56 and 70. Axial plain bearings 74 and 76 are also provided in the openings 56 and 70 and can also be supported on the steps of the openings 56 and 70. The pivot pins 66 and 68 can be supported with their end faces on the axial plain bearings 74 and 76. Bulges which protrude inwards are provided on the axial plain bearings 74 and 76. The end faces of the pivot pins 66 and 68 can be supported on the bulges.

The joint device 10 also comprises the centering device 48. The centering device 48 is provided inside the joint forks 12 and 14. The centering device 48 comprises the centering sleeve 50 and a centering pin 78 which is received at least in sections in the centering sleeve 50. The centering pin 78 is held by the nut 52 on the bracket 46. The centering sleeve 50 is fastened to the bracket 44 via the nut 80. The centering device 48 thus defines an axis of rotation about which the joint forks 12 and 14 and the bearing elements 18, 42 coupled to the joint forks 12 and 14 can be rotated relative to each other with elastic deformation of the coupling elements 26, 28, 34, 86. An elastic layer 82 and a bushing 54 which receives the centering pin 78 in sections are accommodated in the centering sleeve 50. The elastic layer 82 establishes a connection between the centering sleeve 50 and the bushing 84. The centering device 48 can act as an axial plain bearing in order to be able to compensate for elastic deformations of the coupling elements 22, 24, 26, 28, 30, 32, 34, 86 in the axial direction of the joint G.

The joint G, the damping arrangement 20 and the centering device 48 are arranged coincident, i.e., the pivot points of the damping arrangement 20, the joint G and the centering device 48 coincide at a point KD. As a result, the damping arrangement 20 does not have to assume any articulation angles, which leads to an improved service life of the damping arrangement 20. The joint device 10 is also virtually free of articulation-and-return forces, since the damping arrangement 20 is essentially not deformed in the event of a pure articulation load.

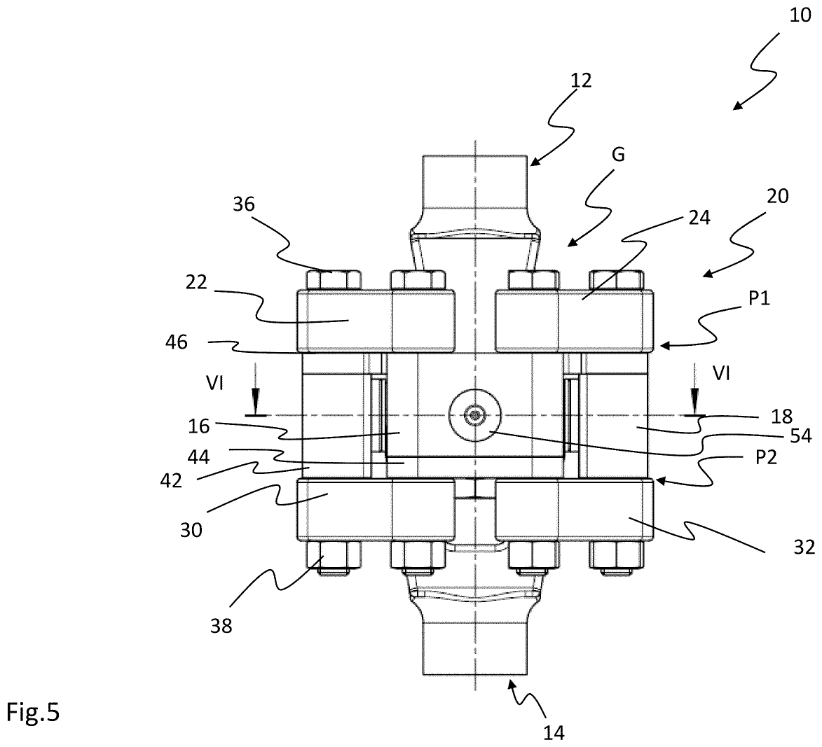

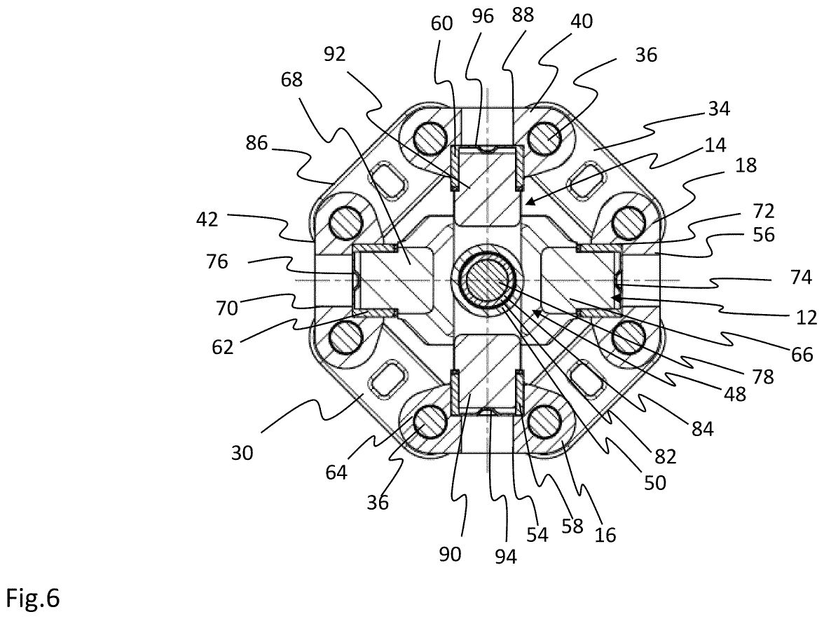

FIG. 5 corresponds to the view according to FIG. 3, with the section line VI-VI being drawn in FIG. 5. FIG. 6 shows a sectional view along the section line VI-VI in FIG. 5. The bearing elements 16, 18, 40, 42 are connected to each other via the coupling elements 30, 32, 34, 86. The elastic element 30 connects the bearing element 42 and the bearing element 16. The elastic element 32 connects the bearing elements 16 and 18. The elastic element 34 connects the bearing elements 18 and 40. The elastic element 86 in turn connects the bearing elements 14 and 16. The damping arrangement 20 formed by the bearing elements 16, 18, 40, 42 thus establishes a torque transmitting coupling between the joint forks 12 and 14. The bolts 36 extend through the openings 64 into the bearing elements 16, 18, 40, 42 to hold the coupling elements 30, 32, 34, 36 on the bearing elements 16, 18, 40, 42.

The bearing elements 16, 18, 40, 42 have openings 54, 56, 70 and 88. The pivot pins 66 and 68 of the joint fork 12 are accommodated in the openings 56 and 70 (see FIGS. 3 to 5). The pivot pins 90 and 92 of the joint fork 14 are received in the openings 54 and 88 (see FIGS. 3 to 5). The pivot pins 66, 68, 90 and 92 are supported via bearings 58, 60, 62 and 72 in the openings 54, 56, 70 and 88 of the bearing elements 16, 18, 40, 42. In addition, axial plain bearings 74, 76, 94 and 96, on which the end faces of the pivot pins 66 and 68, 90, 92 can be supported, are provided in the openings 54, 56, 70, 88. The bearings 58, 60, 62, 72 are designed as needle bearings. The bearings 58, 60, 62, 72 and the axial plain bearings 74, 76, 94, 96 can be designed as a bearing unit. The openings 54, 56, 70 and 88 are stepped so that the bearings 58, 60, 62, 72, 74, 76, 94, 96 can be supported on the step of the openings 54, 56, 70 and 88. The centering device 48 with the centering sleeve 50 and the centering pin 78 can be seen radially inside the pivot pins 66, 68, 90 and 92. The elastic layer 82, which connects the centering sleeve 50 to the bushing 84 which receives the centering pin 78, is provided between the centering pin 78 and the centering sleeve 50.

Because of the bolted connection of the brackets 44 and 46 to the centering device 48, the joint device 10 can be disassembled quickly and easily—for example, in order to replace the elastic coupling elements 22, 24, 30, 32.

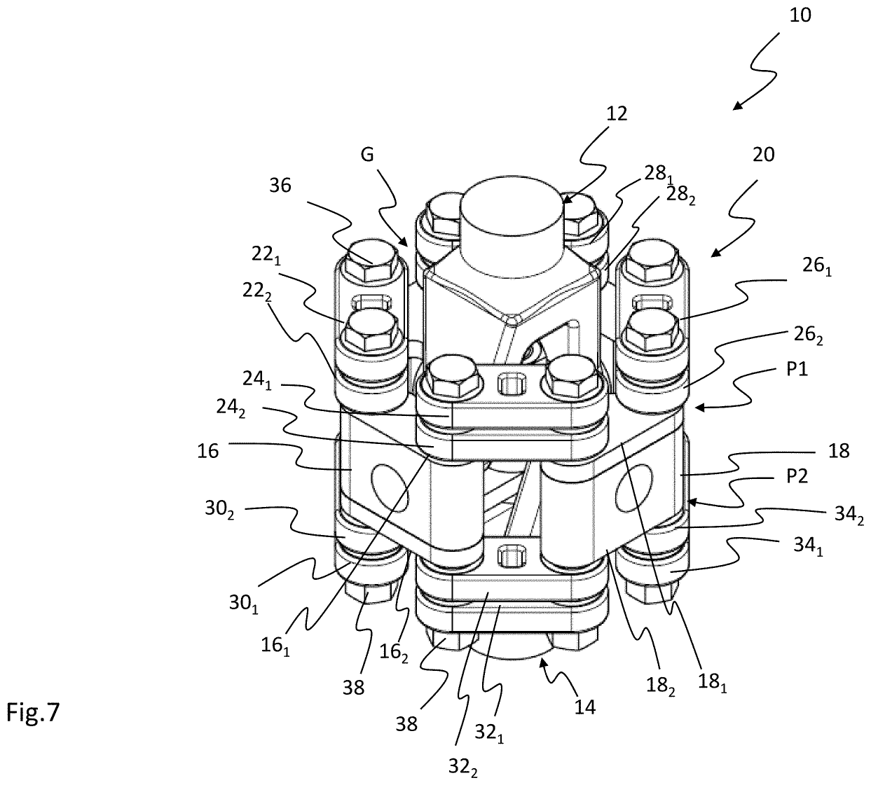

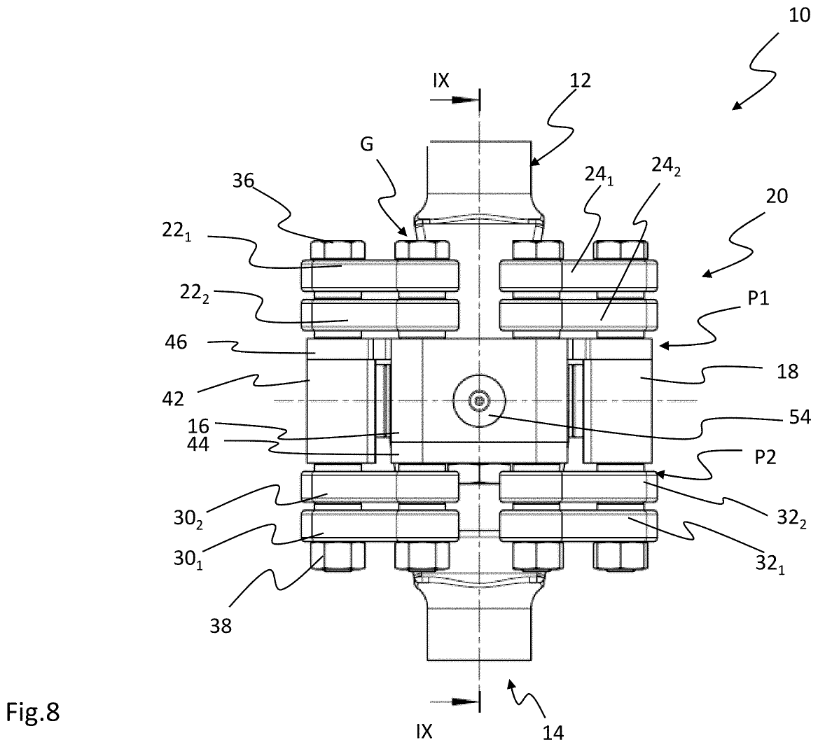

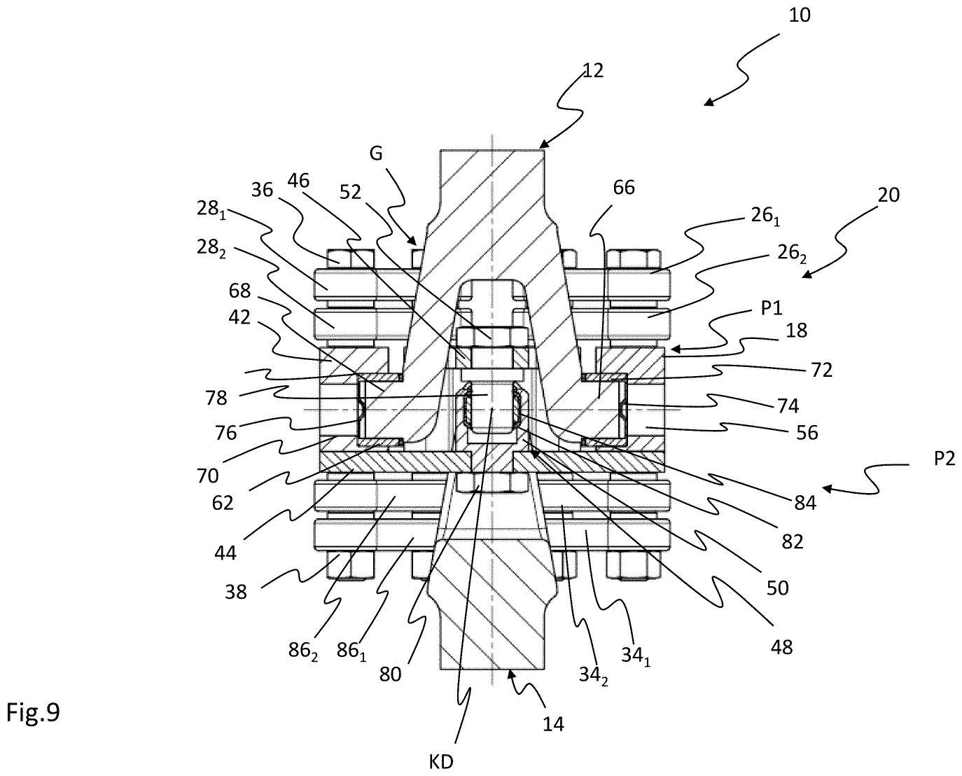

FIGS. 7 to 9 show different views of a joint device 10 according to a second embodiment. The essential difference between the embodiment described with reference to FIGS. 1 to 6 and the second embodiment is that the damping device 20 arranged in the axial direction next to the bearing elements 16, 18, 40, 42 has four levels instead of two levels. Four elastic coupling elements 22₁, 22₂, 24₁, 24₂, 26₁, 26₂, 28₁, 28₂ and 30₁, 30₂, 32₁, 32₂, 34₁, 34₂ are arranged on each axial fastening surface 16₁, 16₂, 18₁, 18₂, 40₁, 40₂, 42₁, 42₂ of the bearing elements 16, 18, 40, 42. The elastic coupling elements 22₁, 22₂, 24₁, 24₂, 26₁, 26₂, 28₁, 28₂ and 30₁, 30₂, 32₁, 32₂, and 34₁, 34₂ extend in pairs parallel to each other between the bearing elements 16, 18 to be connected. One of the bolts 36 thus connects four elastic coupling elements 22₁, 22₂, 24₁, 24₂, 26₁, 26₂, 28₁, 28₂ and 30₁, 30₂, 32₁, 32₂, 34₁, 34₂ arranged with a corresponding bearing element 16, 18. For example, the bolt 36 connects the coupling elements 24₁, 24₂, 32₁ and 32₂ to the bearing element 16 and its bracket 44.

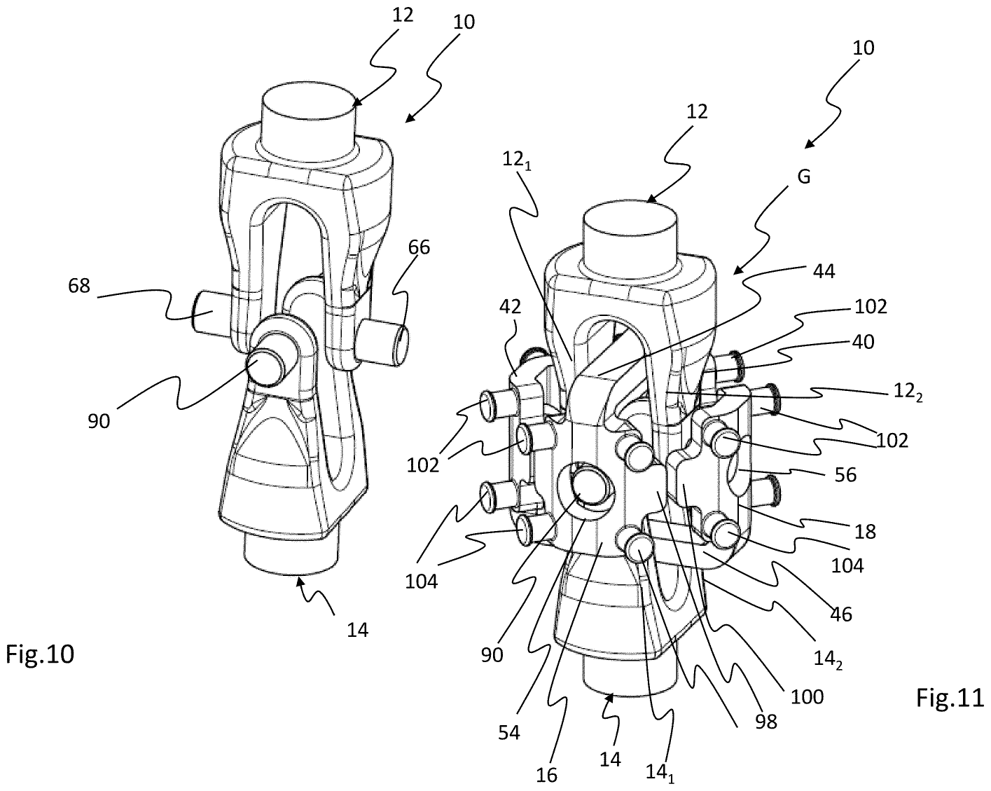

FIGS. 10 to 13 show perspective views of a joint device 10 according to a third embodiment of the invention. The joint forks 12 and 14 are shown in FIG. 10. Pivot pins 66, 68, 90 and 92 are formed on the joint forks 12 and 14, only the pivot pin 90 of the joint fork 14 being shown in FIG. 10. The pivot pins 66, 68, 90 and 92 extend outwards in the radial direction.

In FIG. 11, the joint forks 12 and 14 are shown together with the bearing elements 16, 18, 40 and 42. The bearing elements 16 and 40 are connected to each other via the bracket 44. The bearing elements 18 and 42 are connected to each other via a bracket 46. The brackets 44 and 46 are integrally formed with the bearing elements 16, 18, 40, 42. The bracket 44 which connects the bearing elements 16 and 40 assigned to the joint fork 14 extends between the two fork arms 12₁ and 12₂ of the joint fork 12. In the same way, the bracket 46 which connects the bearing elements 18 and 42 assigned to the joint fork 12 extends between the fork arms 14₁ and 14₂. According to this embodiment, the bearing elements 16, 18, 40, 42 are curved at least in sections. The bearing elements 16, 18, 40 and 42 thus extend in sections around the joint forks 12 and 14. Limit stop projections 98, 100 are formed on the bearing elements 16, 18, 40, 42 and each project in the direction of the respectively adjacent bearing element 16, 18, 40, 42. With the limit stop projections 98 and 100, a positive connection between the adjacent bearing elements 16, 18, 40, 42 can be produced if the damping arrangement (not shown in FIG. 11) should fail. By means of the brackets 44 and 46 coupled to the joint forks 12 and 14 via the bearing elements 16, 18, 40, 42, if the damping arrangement 20 fails, the joint forks 12 and 14 can be prevented from detaching from each other or from falling apart in the axial direction. The brackets 44 and 46 thus contribute to the failsafe running function described above. The limit stop projections 98 and 100 form an overload protection for the fiber packages (not shown), because the abutment of the limit stop projections 98 and 100 against each other prevents the fiber packages from being overstretched.

Coupling elements 102, 104 are provided on each bearing element 16, 18, 40, 42. The coupling elements 102, 104 serve to attach the damping arrangement (not shown) to the bearing elements 16, 18, 40, 42. The coupling elements 102 are arranged on an axial end region of the bearing elements 16, 18, 40 and 42. The coupling elements 104 are arranged on the opposite axial end region of the bearing elements 16, 18, 40 and 42. The coupling elements 102 and the coupling elements 104 are thus spaced apart from each other in the axial direction. Each bearing element 16, 18, 40 and 42 has a total of four coupling elements 102, 104. The coupling elements 102 and 104 protrude in the radial direction from the bearing elements 16, 18, 40, 42. The coupling elements 102 and 104 are bolt- or pin-shaped. The coupling elements 102, 104 have an enlarged diameter at their free ends.

The bearing elements 16, 18, 40, 42 each have an opening, of which only the openings 54 and 56 are shown in FIG. 11. The pivot pin 90 of the joint fork 14 can be seen in the opening 54 of the bearing element 16.

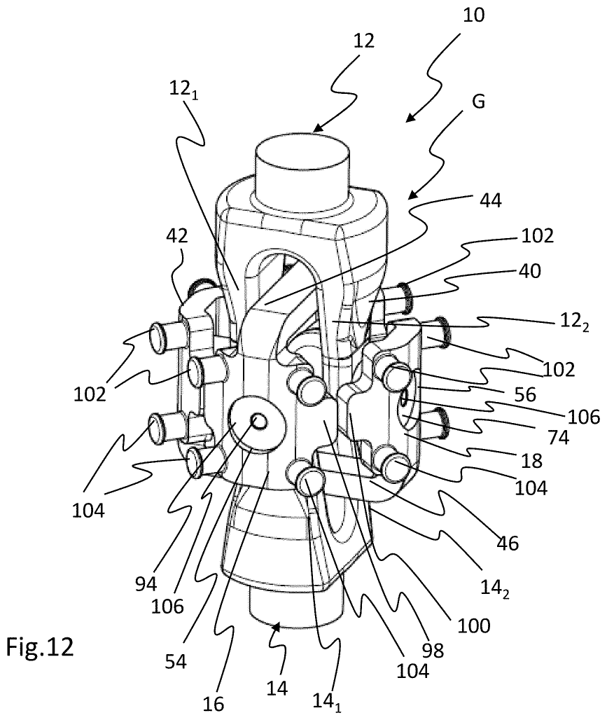

FIG. 12 is relatively similar to the view of FIG. 11. The only difference between FIGS. 11 and 12 is that in FIG. 12 the bearings 74 and 94 are shown in the openings 54 and 56 of the bearing elements 16 and 18. The pivot pins (see FIG. 11) can be supported in the axial and radial directions on the bearings 74 and 94. For the radial support of the end faces of the pivot pins (not shown), the axial plain bearings 74, 94 have a radially inwardly directed bulge 106, which appears as an indentation in the view according to FIG. 12.

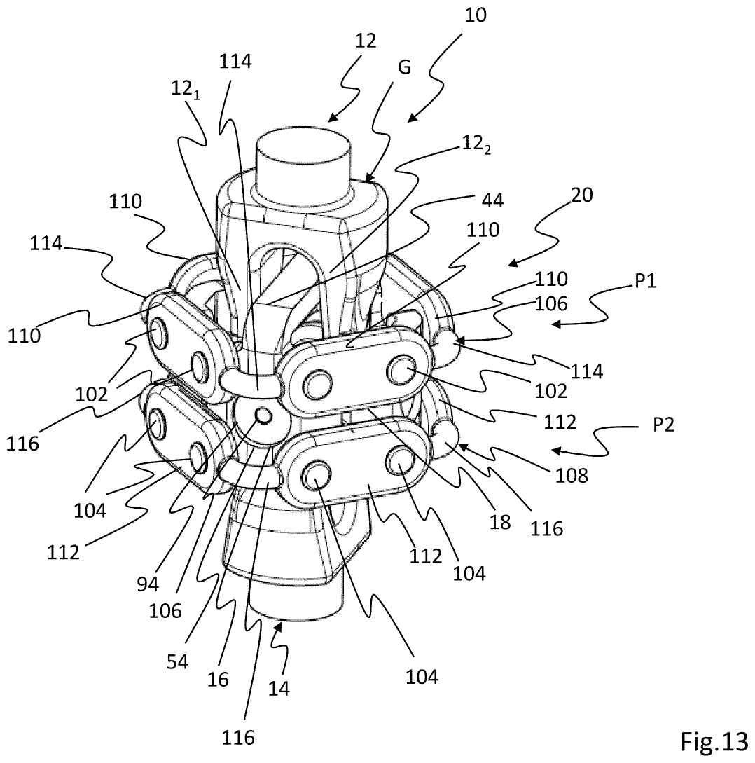

FIG. 13 shows a perspective view of the joint device 10 in which the joint device 10 is shown with the damping arrangement 20. According to this embodiment, the damping arrangement 20 is composed of two annular damper parts 106 and 108. According to this embodiment, the two damper parts 106 and 108 are designed as closed rings. The damper parts 106 and 108 of the damping arrangement 20 are attached to the joint device 10 at positions P1 and P2 which are offset in the axial direction. The damper parts 106 and 108 are coupled via the coupling elements 102 and 104 to the bearing elements 16, 18, 40, 42, of which only the bearing elements 16 and 18 are shown in FIG. 13. The damper parts 106 and 108 can be stuck onto the coupling elements 104 and 106, the coupling elements 102 and 104 holding the damper parts 106 and 108 on the bearing elements 16, 18 via their enlarged end sections.

The damper parts 106 and 108 have coupling portions 110 and 112 with which the damper parts 106 and 108 establish a connection between two adjacent bearing elements 16, 18. Each of the damper parts 106 and 108 has four such coupling portions 110, 112. The coupling portions 110, 112 are connected to each other via connecting portions 114, 116, so that the damper parts 106 and 108 are designed as a closed ring. When the damping arrangement 20 and/or the damper parts 106 and 108 are assembled, the annular damper parts 106, 108 are widened and “drawn” over the joint forks 12, 14 and/or the bearing elements 16, 18, 40, 42. The elastic material of the damper parts 106 and 108 can generate a force acting inwardly in the radial direction, which first presses the damper parts 106 and 108 onto the coupling elements 102, 104 and can then hold them on the coupling elements 102, 104 of the bearing elements 14, 16, 40, 42. Each coupling portion 110, 112 connects two coupling elements 102 or 104 from adjacent bearing elements 16, 18, 40, 42. One of the coupling portions 110 of the damper part 106 connects, for example, a coupling element 102 of the bearing element 16 to a coupling element 102 of the bearing element 18.

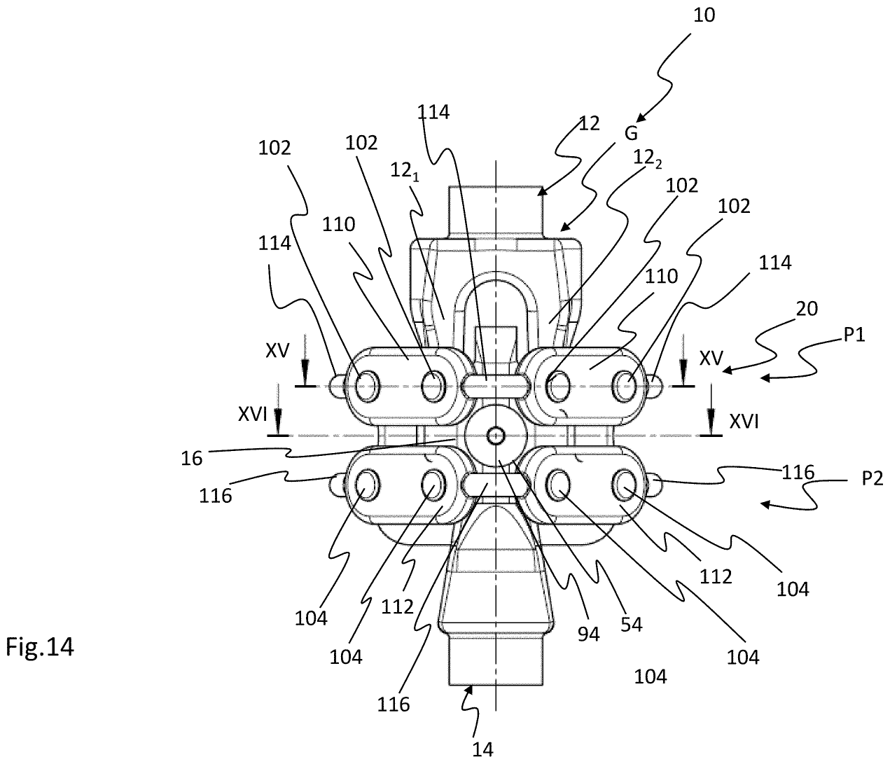

FIG. 14 shows a side view of the joint device 10. The damping arrangement 20 is composed of the two damper parts 106 and 108. The two damper parts 106 and 108 are coupled to the bearing elements 16, 18, 40, 42 at different axial positions P1 and P2. Positions P1 and P2 are offset from each other in the axial direction, such that there is an axial distance between damper parts 106 and 108.

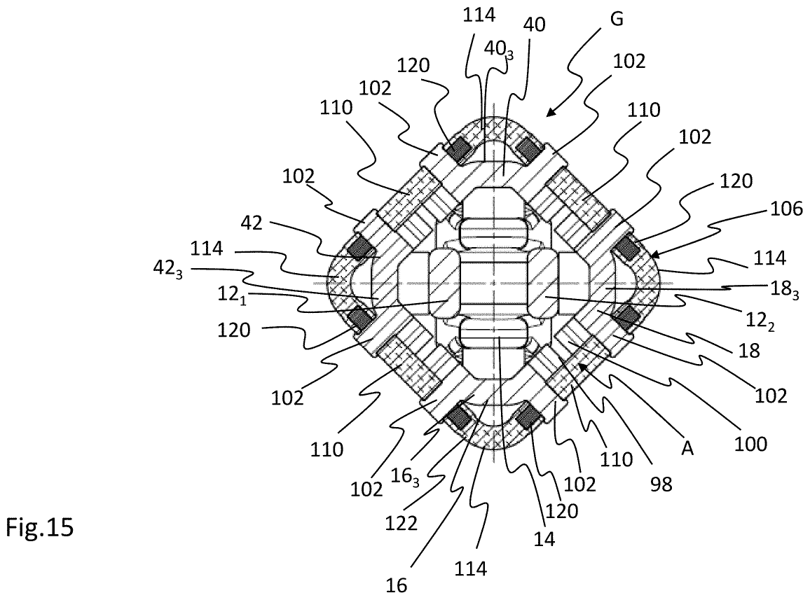

FIG. 15 shows a sectional view along the section line XV-XV in FIG. 14. FIG. 15 shows in particular the damper part 106 of the damping arrangement 20 (see FIG. 14). In FIG. 15 it is clear that the damper part 106 extends as a closed ring radially on the outside around the bearing elements 16, 18, 40, 42. The damper part 106 is composed of alternately arranged coupling portions 110 and connecting portions 114, which connect two coupling portions 110 to each other. Each coupling portion 110 is coupled to two adjacent bearing elements 16, 18, 40, 42 via two coupling elements 102. Each coupling element 102 extends through an opening into the coupling portions 110. The coupling portions 110 each have a fiber package 120 which loops around the coupling elements 102 of adjacent bearing elements 16, 18, 40, 42 and couples the adjacent bearing elements 16, 18, 40, 42 to each other in a force-transmitting manner. The fiber packages 120 are embedded in the elastic material 122 of the annular damper part 106. The fiber packages 120 extend exclusively in the coupling portions 110. No fiber packages are provided in the curved connecting portions 114. The connecting portions 114 thus consist exclusively of an elastic material. The connecting portions 114 serve only to connect two adjacent coupling portions 120 and to generate the fastening force acting radially inwards.

The bearing elements 16, 18, 40, 42 are curved or angled. The pivot pins of the joint forks 12 and 14 are accommodated in the curved regions 16₃, 18₃, 40₃, 42₃. The coupling elements 102 are formed on the bearing elements 16, 18, 40, 42 laterally next to the curved regions 16₃, 18₃, 40₃, 42₃. The coupling elements 102 are formed in one piece with the bearing elements 16, 18, 40, 42. The same applies to the coupling elements 104 (see FIGS. 11 to 13). The bearing elements 16, 18, 40, 42 extend in a curved or angled manner such that the mutually opposing surfaces of the limit stop projections 98 and 100 of two adjacent bearing elements 16, 18, 40, 42 run essentially parallel to each other. A predetermined distance A is established between the limit stop projections 98 and 100. If an angle of rotation between the joint forks 12 and 14 and the connected bearing elements 16, 18, 40, 42 is exceeded, the limit stop projections 98 and 100 can come into abutment. This forms an overload protection for the fiber packages 120, which prevents the fiber packages 120 from being over-elongated or overstretched. By the limit stop projections 98 and 100 being in abutment against each other, the failsafe running function described above can also be provided and/or facilitated.

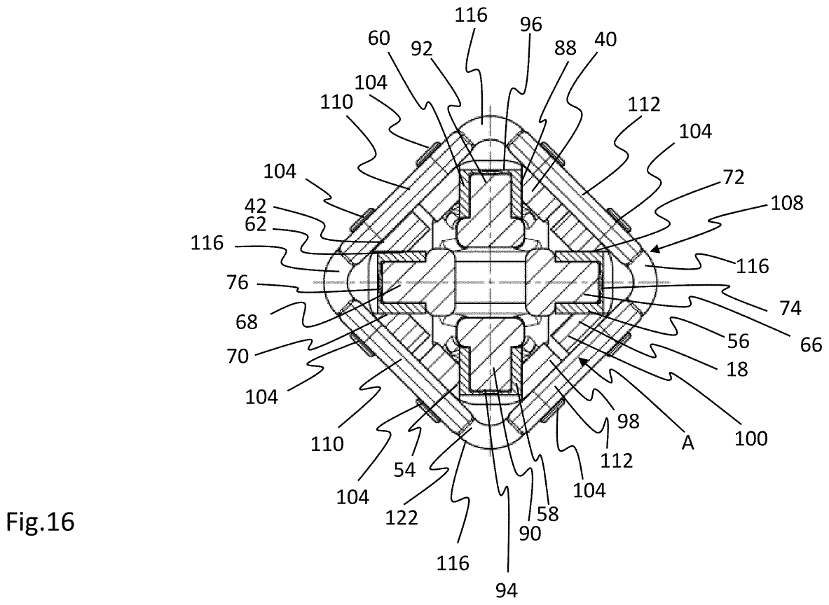

FIG. 16 shows a sectional view along the section line XVI-XVI in FIG. 14. The pivot pins 66, 68, 90 and 92 are accommodated via bearings 58, 60, 62, 72 in the openings 54, 56, 70 and 88 of the bearing elements 16, 18, 40, 42. Furthermore, the axial plain bearings 74, 76, 94, 96 are provided, on which the pivot pins 66, 68, 90 and 92 can be supported.

The annular damper part 108 of the damping arrangement 20 surrounds the bearing elements 16, 18, 40, 42. The damper part 108 is coupled to the bearing elements 16, 18, 40, 42 in a force-transmitting manner via the coupling elements 104. The damper part 108 comprises the coupling portions 112 and the connecting portions 116, which connect the coupling portions 112 to each other. In the coupling portions 112 there are fiber packages, not shown, which are embedded in the elastic material of the damper part 108.

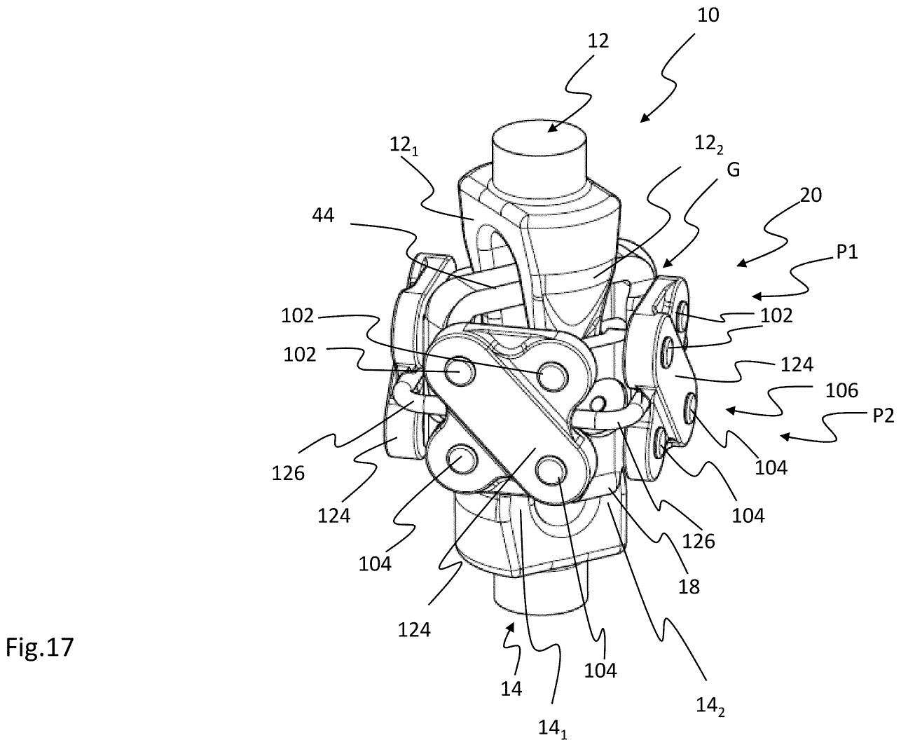

FIGS. 17 to 20 show different views of a joint device 10 according to a fourth embodiment. The structure of the joint forks 12 and 14, the bearing elements 16, 18, 40, 42 and the brackets 44 and 46 corresponds to the embodiment described with reference to FIGS. 10 to 16. The statements regarding the components mentioned in connection with the embodiment described above therefore also apply to the embodiment shown in FIGS. 17 to 20.

The differences between the two embodiments lie in the structure of the damping arrangement 20. As can be seen in FIG. 17, the damping arrangement has coupling portions 124 and connecting portions 126 which connect the coupling portions 124 to each other. The damping arrangement 20 is annular. The coupling portions 124 are “X”-shaped in the broadest sense. The coupling portions 124 are coupled to the bearing elements 16, 18, 40, 42 via the coupling elements 102 and 104, wherein only the bearing element 18 are shown in FIG. 17. The coupling elements 102 and 104 are offset from each other in the axial direction, so that the coupling portions 124 are coupled to the bearing elements 16, 18, 40, 42 at positions P1 and P2 which are offset from each other in the axial direction.

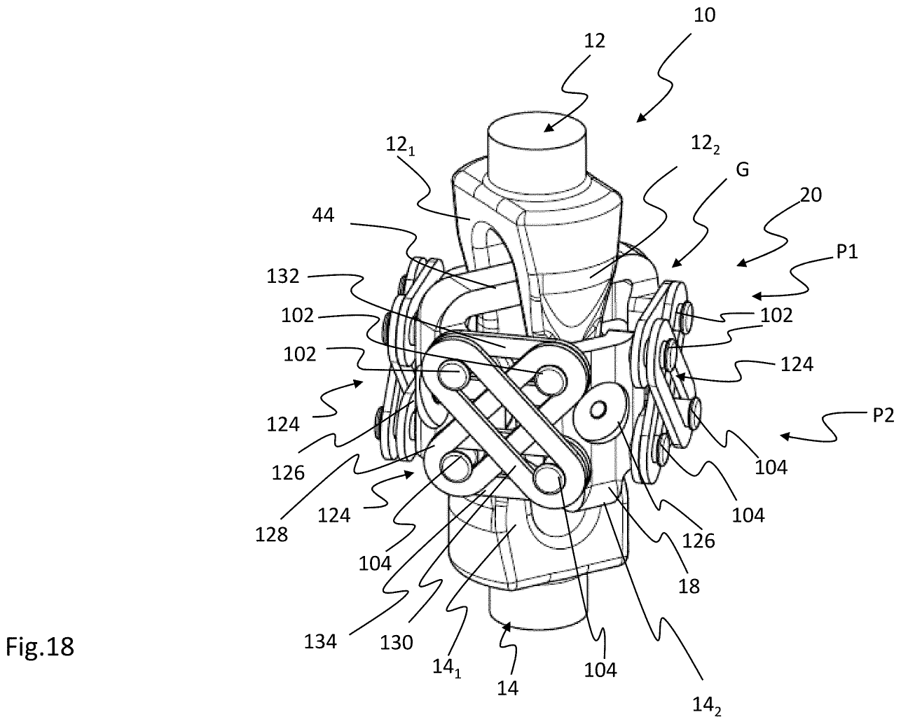

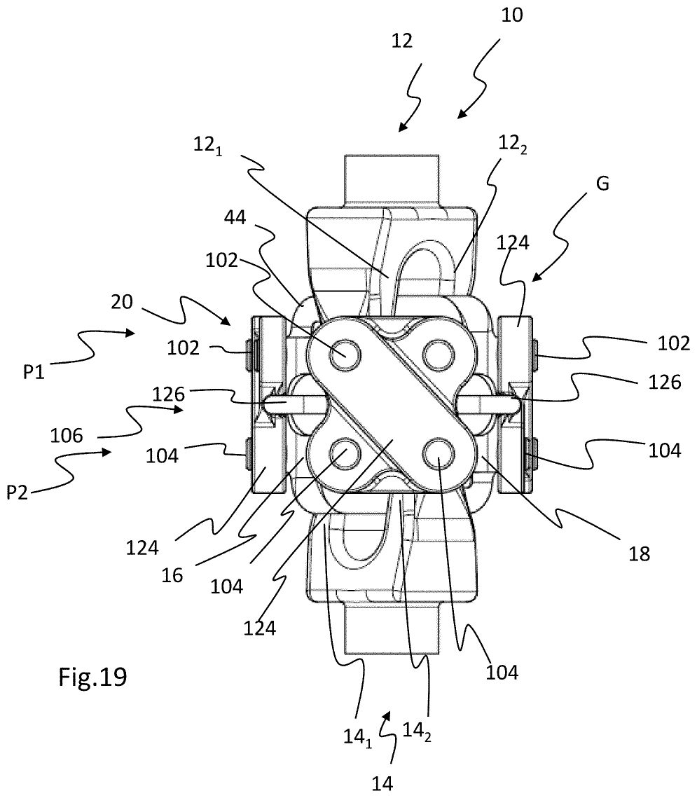

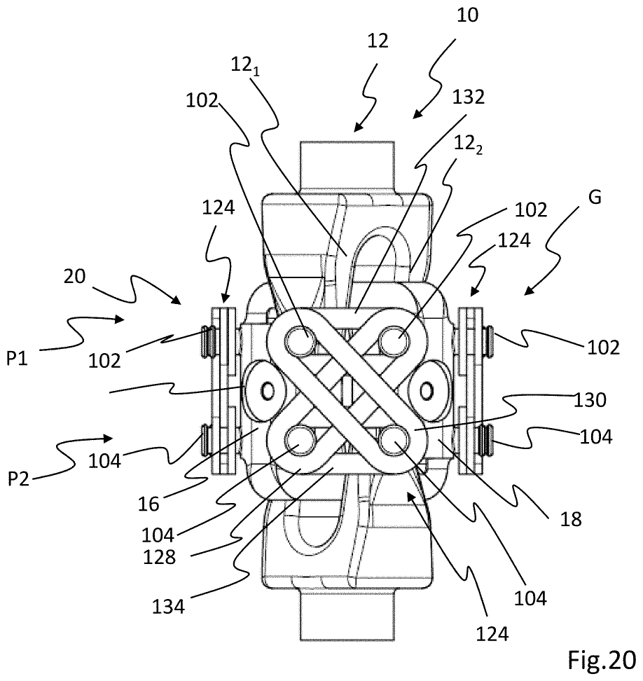

FIGS. 18 and 20 show the damping arrangement 20 without an elastic sheathing, the damping arrangement 20 being shown as a whole in side view according to FIG. 19. Each coupling portion 124 has four fiber packages 128, 130, 132 and 134. The fiber packages 128 and 130 intersect and each couple one coupling element 102 and one coupling element 104 of adjacent bearing elements 16, 18, 40, 42 in a force-transmitting manner. The fiber packages 132 and 134 extend parallel to each other and loop around two coupling elements 102 of adjacent bearing elements 16, 18, 40, 42. The obliquely extending fiber packages 132 and 134 can serve to support an axial force. Two of the fiber packages 128, 130, 132 and 134 loop around each coupling element 102, 104 in this embodiment.

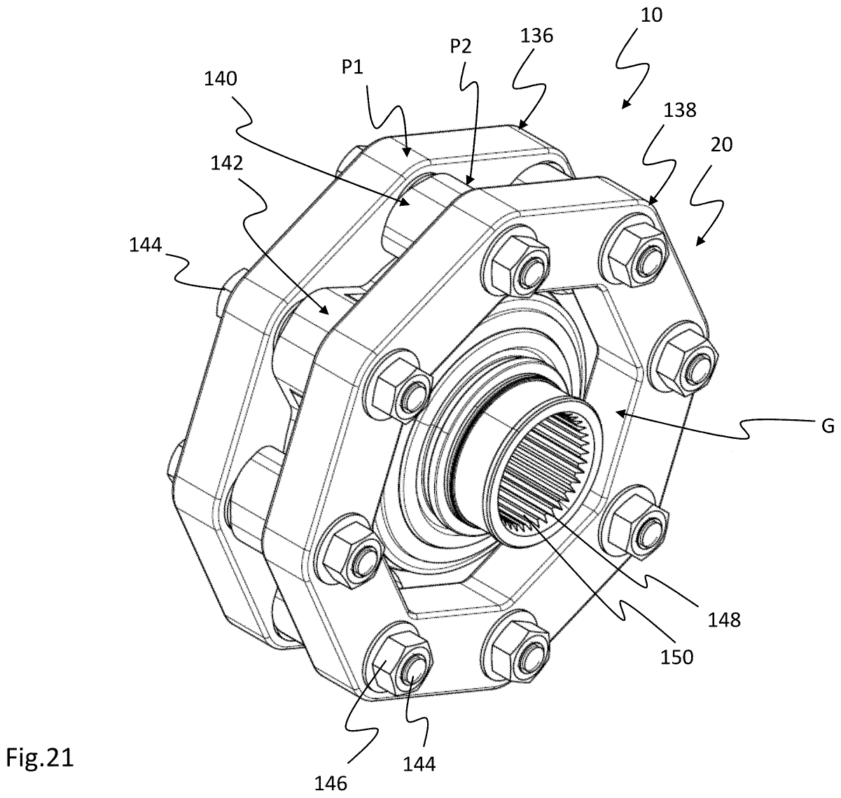

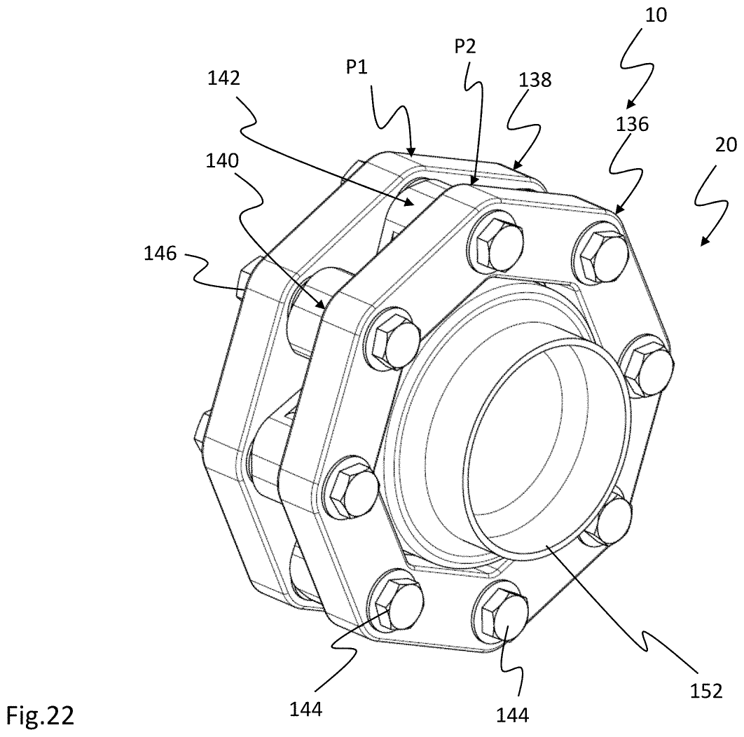

FIGS. 21 and 22 show perspective views of a joint device 10 according to a fifth embodiment. The joint device 10 comprises a joint G and a damping arrangement 20 which is composed of two annular damper parts 136 and 138. The damper parts 136 and 138 are coupled to the joint G at positions P1 and P2 which are offset in the axial direction. For this purpose, a coupling flange 140 is provided which is connected to a flange 142 in a torque transmitting manner via the damper parts 136 and 138. The damper parts 136 and 138 are connected to the flanges 140, 142 by bolts 144 and nuts 146.

The joint G has a receiving opening 148. The receiving opening 148 has an internal toothing 150. The receiving opening 148 can receive a shaft section (not shown) and can be connected to this shaft section in a torque transmitting manner via the internal toothing 150. The flange 142 has a tubular extension 152, with which the flange 142 can be connected to a shaft section (not shown).

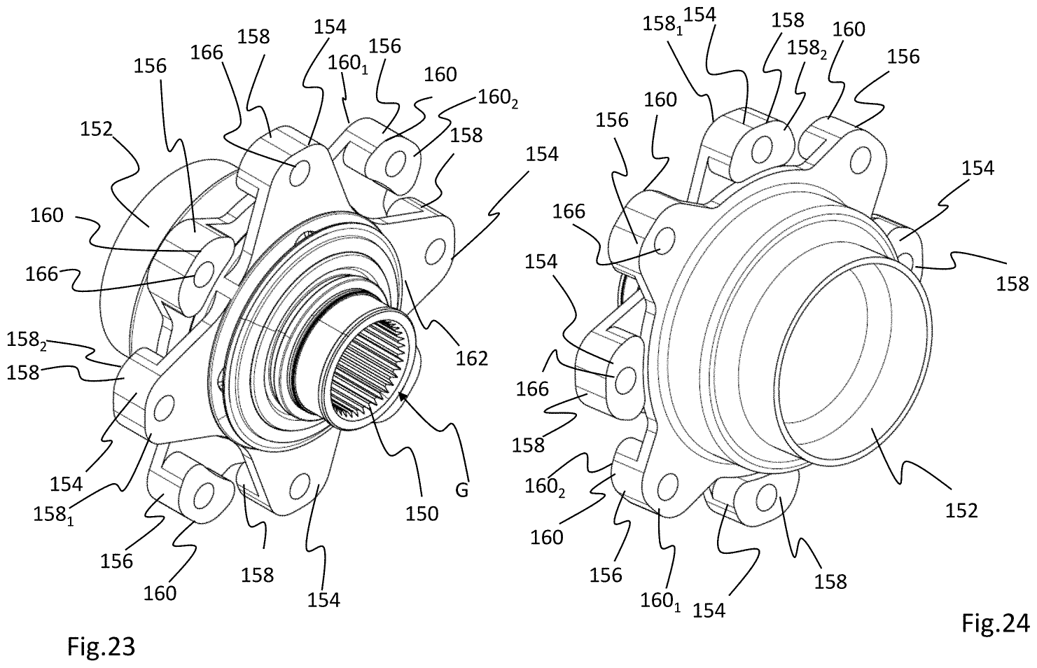

FIGS. 23 and 24 show perspective views of the joint device 10 without the damping arrangement 20. The joint G is accommodated in the coupling flange 140 at least in sections. The coupling flange 140 has four flange arms 154 which extend in the radial direction. The flange 142 also has four flange arms 156 which protrude in the radial direction. The flange arms 154 and 156 engage in each other. The flange arms 154 and 156 have at their radially outer ends an enlarged head or an enlarged head portion 158 and 160, the axial extent of which is enlarged compared to the plate-shaped regions 162 and 164 of the flanges 140 and 142. The openings 166 through which the bolts 144 extend are formed on the enlarged head portions 158 and 160. Two axial fastening surfaces 158₁, 158₂, 160₁, 160₂ are formed on each head portion and are used for coupling the flanges 140, 142 to the damping arrangement 20. The axial fastening surfaces 158₁, 158₂, 160₁, 160₂ extend essentially parallel to each other. The axial fastening surfaces 158₁, 158₂, 160₁, 160₂ define the positions P1 and P2 for coupling the joint G to the damper parts 136 and 138 of the damping arrangement. The axial fastening surfaces 158₁, 158₂, 160₁, 160₂ are offset from each other in the axial direction.

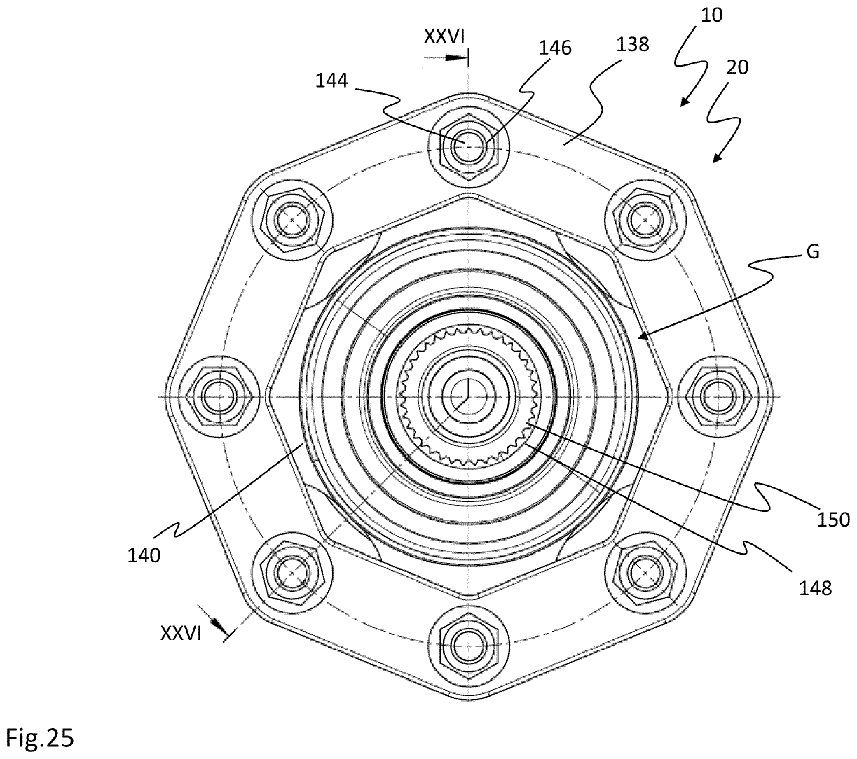

FIG. 25 shows a top view of the joint device 10, showing the joint G, the coupling flange 140 coupled to the joint G and the damper part 138 of the damping arrangement 20.

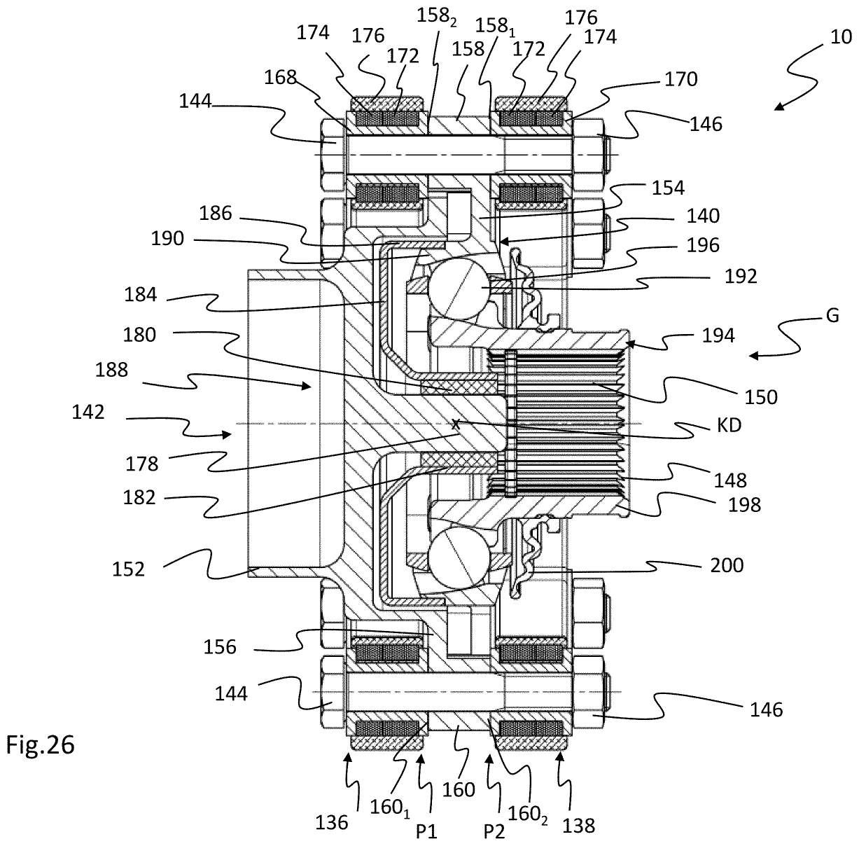

FIG. 26 shows a sectional view along the section line XXVI-XXVI in FIG. 25. The joint G is coupled to the damping arrangement 20 via the coupling flange 140. The damping arrangement 20 is composed of two damper parts 136 and 138. The damper parts 136 and 138 are annular. The damper parts 136 and 138 lie with one of their axial lateral surfaces against the axial fastening surfaces 158₁, 158₂ of the head portion 158 of the coupling flange 140. The damper parts 136 and 138 likewise lie, with the mutually facing axial surfaces, against the axial fastening surfaces 160₁, 160₂ of the head portion 160 of the flange 142. The damper parts 136 and 138 have a coil-shaped bushing 168, 170, and the damper parts 136, 138 lie, with the end faces thereof, against the axial fastening surfaces 158₁, 158₂, 160₁, 160₂ of the flanges 140, 142 and/or of the flange arms 154, 156.

Each damper part 136, 138 has fiber packages 172, 174 which loop around the bushings 168, 170. The fiber packages 172, 174 couple the two flanges 140 and 142 to each other in a torque transmitting manner. The fiber packages 172, 174 are embedded in an elastic body 176 made of elastic material. The fiber packages 172 and 174 differ in their cross-section. The fiber packages 172 have a larger cross-section than the fiber packages 174. The fiber packages 172 are positioned, in the operation of the joint device 10, in a tensile path, so they are loaded upon tension. The fiber packages 172 are located closer to the fastening surfaces 158₁, 158₂, 160₁, 160₂ of the flanges 140, 142 in the axial direction than the fiber packages 174. The fiber packages 174 are positioned in a compression path during the operation of the joint device 10. The tensile force acting on the fiber packages 172 during operation thus has a shorter lever arm than the forces acting on the fiber packages 174.

For this purpose, the bolts 144 extend through the damper parts 136, 138 and the enlarged head portions 158, 160 of the flanges 140, 142. The head of the bolts 144 abuts the bushings 168 of the damper part 136. The nuts 146 with which the bolts 144 are locked abut the bushings 170 of the damper part 138. The damper parts 136, 138 are thus clamped to the head portions 158, 160 of the flange arms 154, 156 with the bolts 144 and the nuts 146. Since the damper parts 136, 138 bear on opposite axial fastening surfaces 158₁, 158₂, 160₁, 160₂ of the head portions 158, 160 of the flange arms 154, 156, the damper parts 136, 138 are coupled to the joint Gin two positions P1 and P2 which are offset in the axial direction.

The flange 142 is provided with a centering pin 178. The centering pin 178 protrudes axially into the receiving opening 148 of the joint G. The centering pin 178 is connected to a centering sleeve 182 via an elastic layer 180. The centering pin 178 and the centering sleeve 182 form a centering device 188 with the elastic layer 180. The centering sleeve 182 is formed on a centering part 184 which extends at an angle in the direction of the coupling flange 140. The centering part 184 has a section 186 which extends in the axial direction and with which the centering part 184 is connected to the coupling flanges 140. The centering sleeve 182 extends in sections into the receiving opening 148 of the joint G. The centering device 188 according to this embodiment can be rigid in the radial direction. The centering device 188 can be designed as an axial plain bearing, so that axial deflections between the flanges 140 and 142 can be compensated for or absorbed.

A housing part 190 of the joint G is formed on the coupling flange 140. The housing part 190 is coupled via bearing balls 192 to a bearing star 194 in a torque transmitting manner. The bearing balls 192 are guided in a cage 196. The bearing star 194 has troughs on its outer circumferential surface in which the bearing balls 192 are received. The bearing balls 192 can compensate for large angular misalignments between two shaft sections to be connected (not shown) by the joint G. The bearing star 194 has a tubular portion 198 in which the receiving opening 148 is formed. A bellows 200 is provided on the tubular portion 198 and extends in the radial direction, and is intended to prevent contamination from penetrating into the joint G. The joint G is designed according to this embodiment as a constant velocity joint.

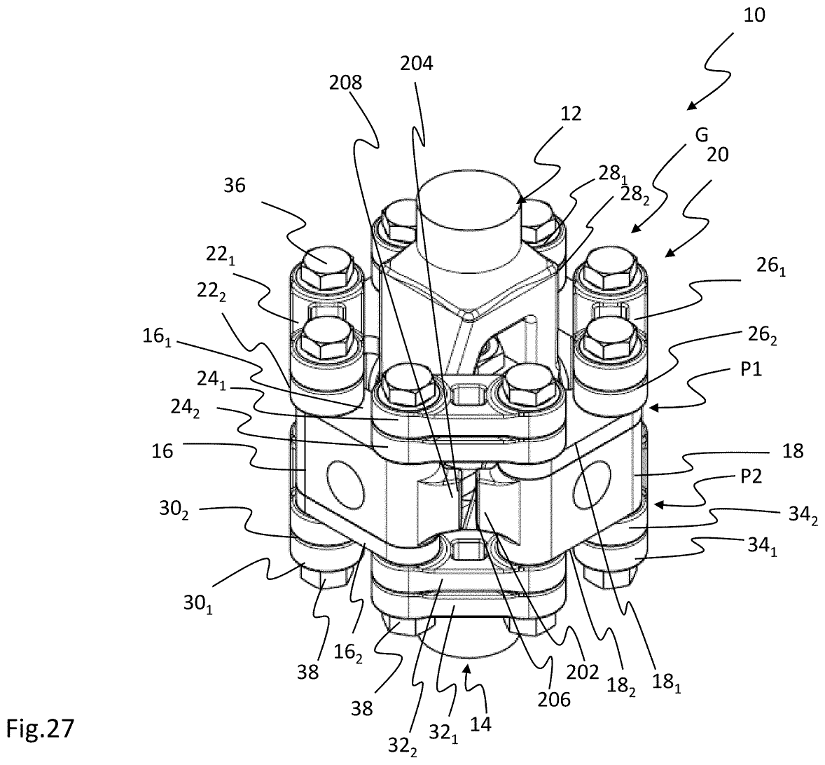

FIGS. 27 to 30 show an embodiment of a joint device 10 which essentially corresponds to the embodiments described with reference to FIGS. 1 to 9. The essential difference from these two embodiments lies in the formation of limit stops 202 and 204 on the bearing elements 16, 18, 40, 42, of which only the bearing elements 16 and 18 are shown in FIG. 22. The limit stops 202 and 204 project in the circumferential direction from the bearing elements 16, 18. The limit stops 202 and 204 each have a limit stop surface 206 and 208. The limit stop surfaces 206 and 208 lie opposite each other. The limit stops 202 and 204 can contribute to the provision of the failsafe running function described above and/or to the provision of an overload protection. A predetermined distance is established between the opposing limit stop surfaces 206 and 208. This predetermined distance can correspond to a maximum permissible relative rotation between the joint forks 12, 14 or between two adjacent bearing elements 16 and 18, 40, 42. The two limit stop surfaces 206 and 208 can, for example, come to abut each other when the coupling elements 22₁, 22₂, 24₁, 24₂, 26₁, 26₂, 28₁, 28₂ and 30₁, 30₂, 32₁, 32₂, 34₁, 34₂ are heavily loaded or damaged. Because of the abutment of the stop surfaces 206 and 208, torque can still be transmitted via the joint device 10. In addition, the abutment of the limit stop surfaces 206 and 208 against each other can also prevent overload of the coupling elements 22₁, 22₂, 24₁, 24₂, 26₁, 26₂, 28₁, 28₂ and 30₁, 30₂, 32₁, 32₂, 34₁, 34₂. This accordingly prevents the coupling elements 22₁, 22₂, 24₁, 24₂, 26₁, 26₂, 28₁, 28₂ and 30₁, 30₂, 32₁, 32₂, 34₁, 34₂ loaded under tension, from being elongated or stretched too much and becoming damaged.

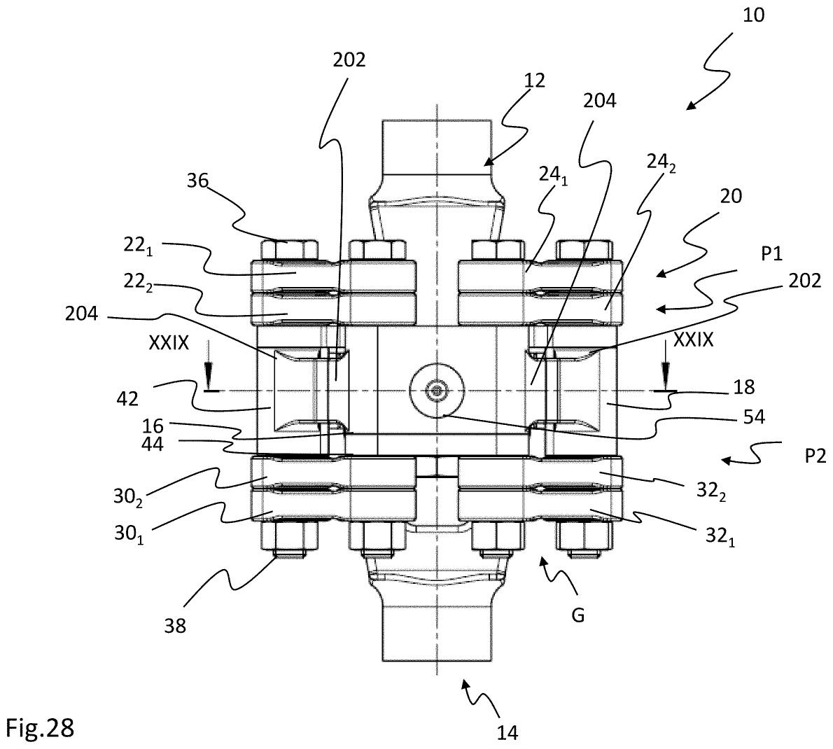

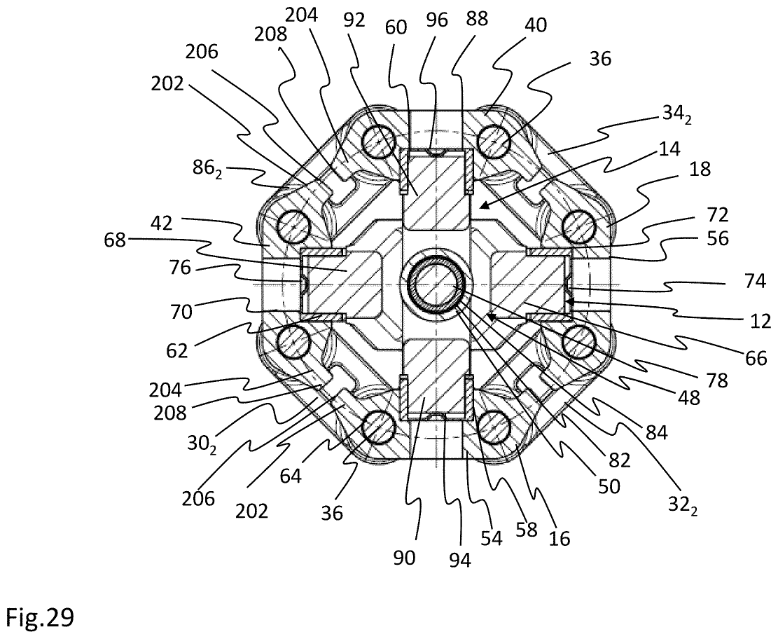

As can be seen in particular in FIGS. 28 and 29, the bearing elements 16, 18, 40 and 42 each have two limit stops 202, 204. The limit stops 202 and 204 of adjacent bearing elements 16, 18, 40, 42 comprise the mutually opposing limit stop surfaces 206 and 208 which, when a predetermined relative rotation between the joint forks 12 and 14 is exceeded, can come to abut each other with elastic deformation of the coupling elements 22₁, 22₂, 24₁, 24₂, 26₁, 26₂, 28₁, 28₂ and 30₁, 30₂, 32₁, 32₂, 34₁, 34₂. Overload protection and/or a failsafe running function can thereby be provided.

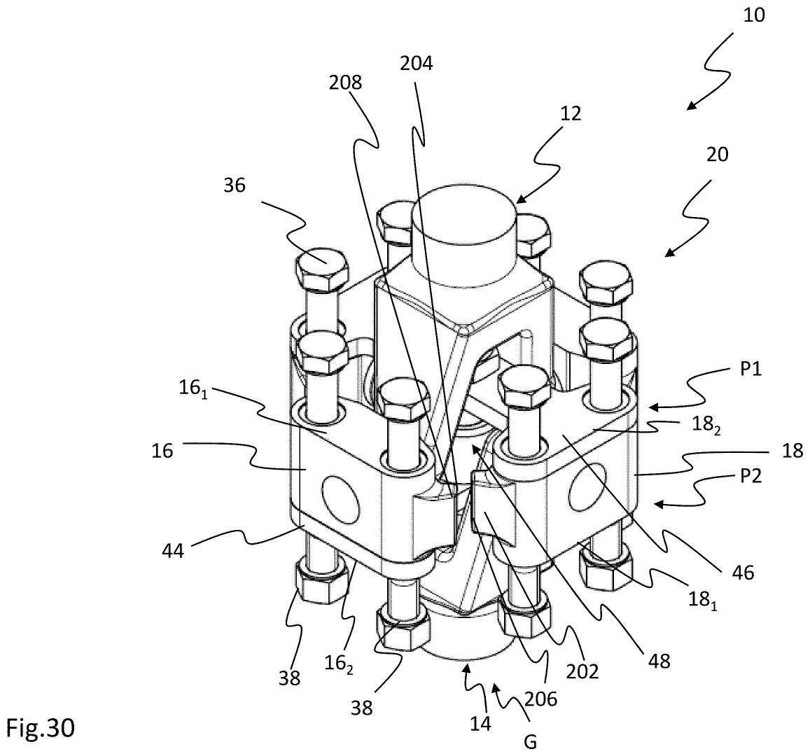

FIGS. 30 to 32 show views of a joint device 10 without elastic elements. The structure of the joint device 10 corresponds to the embodiment described with reference to FIGS. 28 and 29, the coupling elements having been removed. In FIG. 30 it can be seen that the bearing elements 16 and 18 are slightly offset from each other in the axial direction. This can be achieved by the centering device 48 which has a plain bearing or which can be designed as a plain bearing in order to allow deflections in the axial direction between the joint forks 12 and 14.

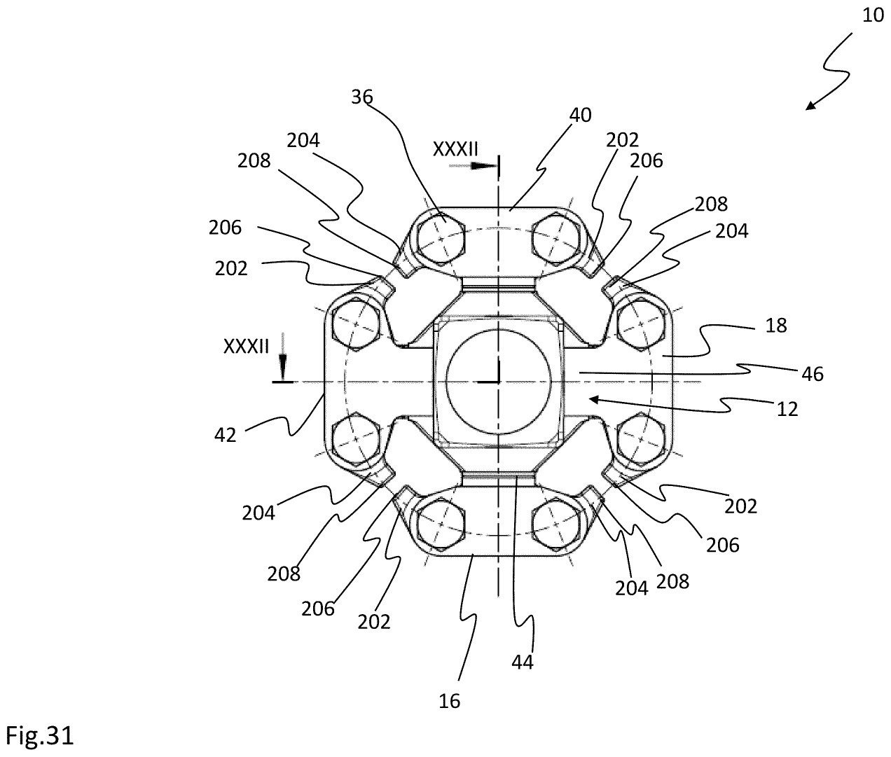

FIG. 31 shows a top view of the joint device 10. FIG. 31 shows the bearing elements 16, 18, 40, 42, the bearing elements 16 and 40 being connected to each other via the bracket 44 and the bearing elements 18 and 42 being connected to each other via the bracket 46. Each of the bearing elements 16, 18, 40, 42 has two limit stops 202 and 204 on which limit stop surfaces 206 and 208 are formed. A predetermined distance is established between the opposite limit stop surfaces 206 and 208 of adjacent bearing elements 16, 18, 40, 42. The limit stop surfaces 206 and 208 can come to abut each other as soon as the relative rotation with elastic deformation of the coupling elements (not shown) between the bearing elements 16, 18, 40, 42 is greater than the predetermined distance.

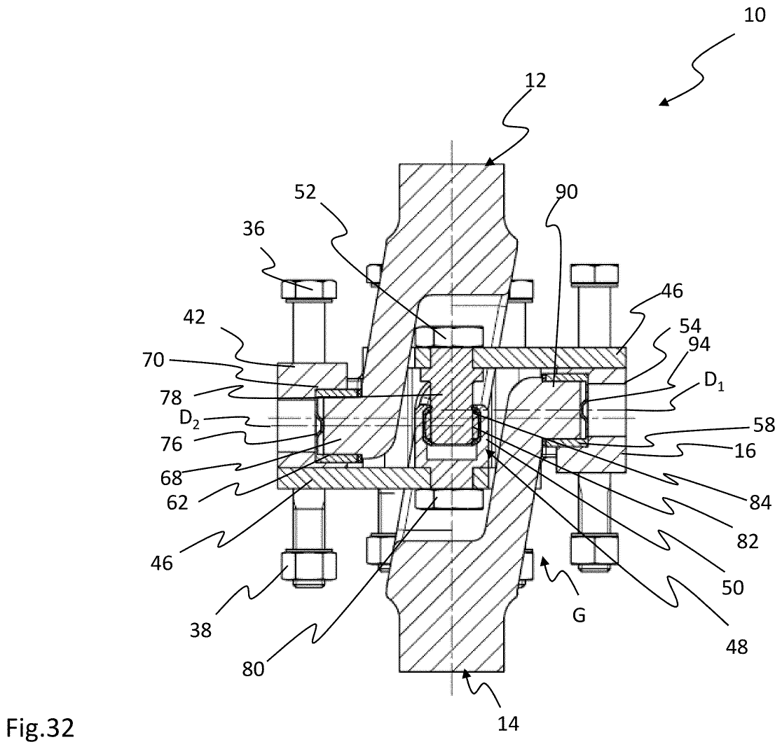

FIG. 32 shows a sectional view along the section line XXXII-XXXII in FIG. 31. In FIG. 32, the joint forks 12, 14 and the bearing elements 16 and 42 are shown. The bearing elements 16 and 42 are connected to the brackets 44, 46, which in turn are rotatably connected to each other via the centering device 48. The centering device 48 is provided inside the joint forks 12 and 14. The centering device 48 comprises the centering sleeve 50 and the centering pin 78, which is received at least in sections in the centering sleeve 50. The centering pin 78 is held by the nut 52 on the bracket 46. An elastic layer 82 and a bushing 54 which receives the centering pin 78 in sections are accommodated in the centering sleeve 50. The elastic layer 82 establishes a connection between the centering sleeve 50 and the bushing 84. The centering device 48 acts as the axial plain bearing, so that relative movements in the axial direction between the joint forks 12, 14 or between the bearing elements 16, 18, 40, 42 are possible over a predetermined path. The centering device 48 can thus accommodate deflections between the joint forks 12 and 14 in the axial direction, which can arise, for example, due to an elastic deformation of the coupling elements in the axial direction of the joint G.

In FIG. 32, the axial deflection between the joint forks 12 and 14 can be seen from the axial offset between the axes of rotation D₁ and D₂, wherein the axis of rotation D₁ is the axis of rotation of the pivot pin 90 in the bearing element 16, and the axis of rotation D₂ is the axis of rotation of the pivot pin 68 in the bearing element 42. In other words, the axis of rotation D₁ constitutes the axis of rotation of the joint fork 14, and the axis of rotation D₂ is the axis of rotation of the joint fork 12. The axial offset between the axes of rotation D₁ and D₂ shows that there is no longer any coincidence in the event of an axial deflection between the joint forks 12 and 14. The joint G or the joint device 10 is still fully functional, however, since the coupling elements (not shown) can absorb the forces and displacements which arise due to the now-absent coincidence.

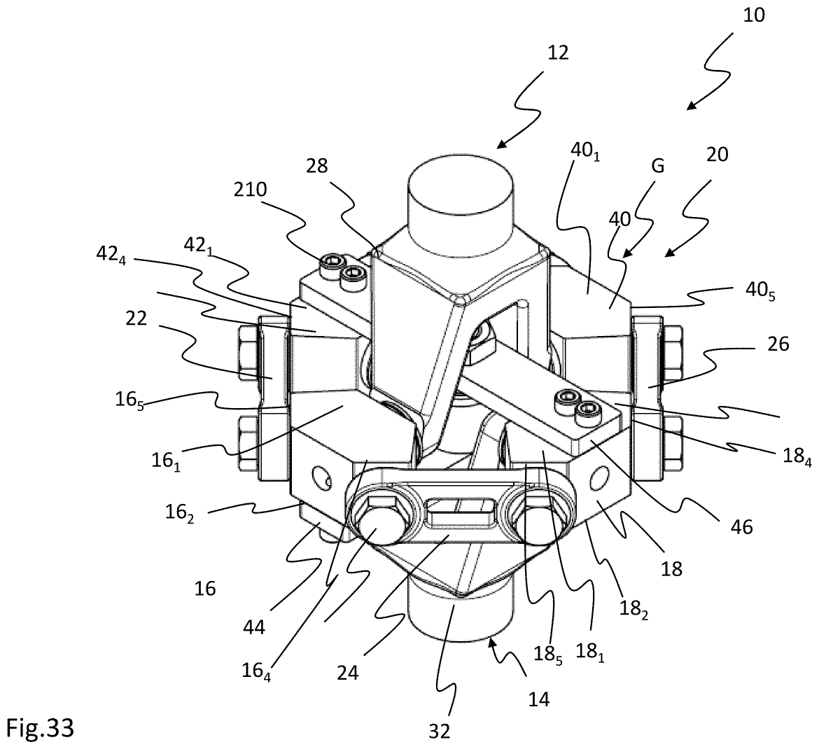

FIG. 33 shows a perspective view of a joint device 10 according to a further embodiment. The joint device 10 has a joint G with two joint forks 12 and 14. Four bearing elements 16, 18, 40 and 42 are arranged on the joint forks 12 and 14. The bearing elements 16 and 40 are connected to each other via the bracket 46. The plate-shaped bracket 44 is connected to two axial fastening surfaces of the bearing elements 16 and 40, of which only the fastening surfaces 16₁, 16₂ and 40₁ are shown in FIG. 33. The bearing elements 18 and 42 are connected to each other via the plate-shaped bracket 46. The bracket 46 is connected to the axial fastening surfaces 18₁ and 42₁. The brackets 44 and 46 are bolted to the bearing elements 16, 18, 40, 42 via the bolts 210.

The joint device 10 comprises the damping arrangement 20. The damping arrangement 20 is formed by a plurality of elastic elements 22, 24, 26, the element 28 not being shown in FIG. 33. The coupling elements 22, 24, 26, 28 are designed like straps and each have at least one fiber package (not shown). The coupling elements 22, 24, 26 28 are connected to radial fastening surfaces of the bearing elements 16, 18, 40, 42, of which only the radial fastening surfaces 16₄, 16₅, 18₄, 18₅, 40₄ and 42₄ are shown in FIG. 33. The elements 22, 24, 26 lie in sections against the radial fastening surfaces 16₄, 16₅, 18₄, 18₅, 40₄ and 42₄. The coupling elements 22, 24, 26 and 28 are bolted to the radial fastening surfaces 16₄, 16₅, 18₄, 18₅, 40₄ and 42₅ via the bolts 36. For this purpose, the bolts 36 extend substantially in the radial direction into the bearing elements 16, 18, 40, 42. One elastic element 22, 24, 26, 28 connects each of two adjacent bearing elements 16, 18, 40, 42, so that each bearing element 16, 18, 40, 42 is connected to two of the coupling elements 22, 24, 26, 28.

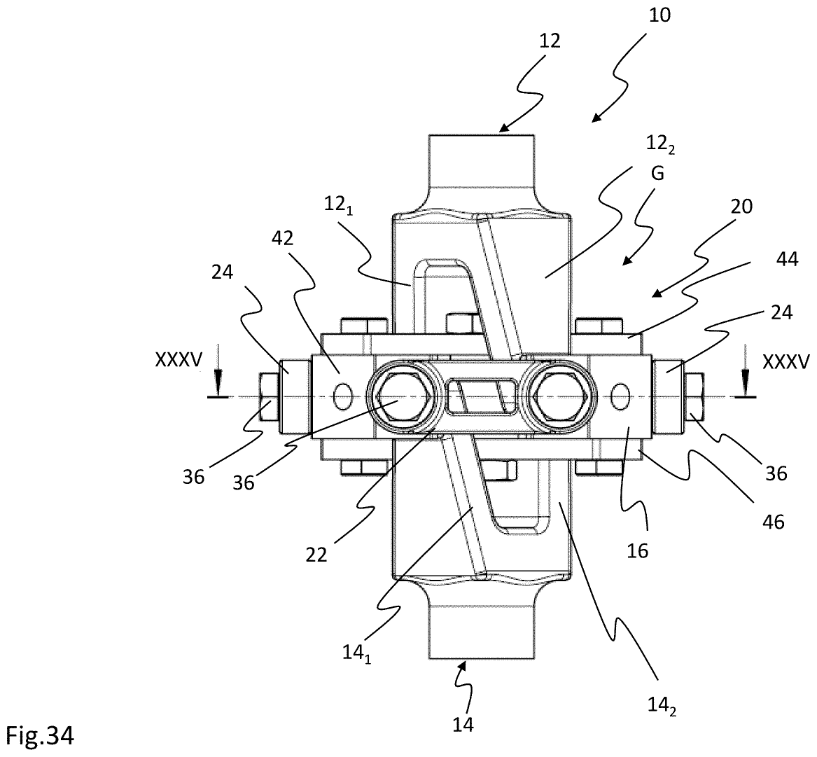

FIG. 34 shows a side view of the joint device 10. The bearing elements 16 and 40 are connected to each other via the bracket 44. The bearing elements 18 and 42 are connected to each other via a bracket 46. The bracket 44 which connects the bearing elements 16 and 40 assigned to the joint fork 14 extends between and through the two fork arms 12₁ and 12₂ of the joint fork 12. In the same way, the bracket 46 which connects the bearing elements 18 and 42 assigned to the joint fork 12 extends between and through the fork arms 14₁ and 14₂.

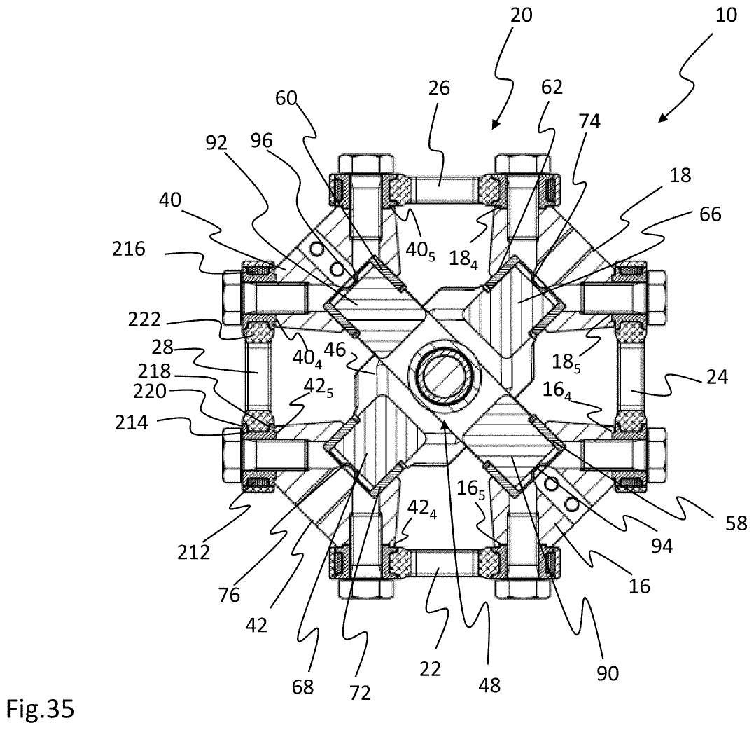

FIG. 35 shows a sectional view along the section line XXXV-XXXV in FIG. 34. The coupling elements 22, 24, 26 and 28 connect two adjacent bearing elements 16, 18, 40, 42. The coupling elements 22, 24, 26 and 28 lie against the fastening surfaces 16₄, 16₅, 18₄, 18₅, 40₄, 40₅, 42₄ and 42₅. The fastening surfaces 16₄, 16₅, 18₄, 18₅, 40₄, 40₅, 42₄ and 42₅ of the individual bearing elements 16, 18, 40, 42 extend at an angle to each other. The fastening surfaces 16₄, 16₅, 18₄, 18₅, 40₄, 40₅, 42₄ and 42₅ extend at an angle of 90° to the axial fastening surfaces of the bearing elements 16, 18, 40, 42.

Each of the coupling elements 22, 24, 26, 28 has a fiber package 212. Each fiber package 212 loops around two bushings 214 and 216. The bushings 214 and 216 have two sections 218 and 220 projecting in the radial direction, between which the fiber package 212 is guided. The fiber package 212 and the bushings 214 and 216 are at least partially embedded in an elastic body 222. The bolts 36 extend through the bushings 214 and 216 in order to connect the respective elastic element 22, 24, 26, 28 to one of the bearing elements 16, 18, 40, 42.

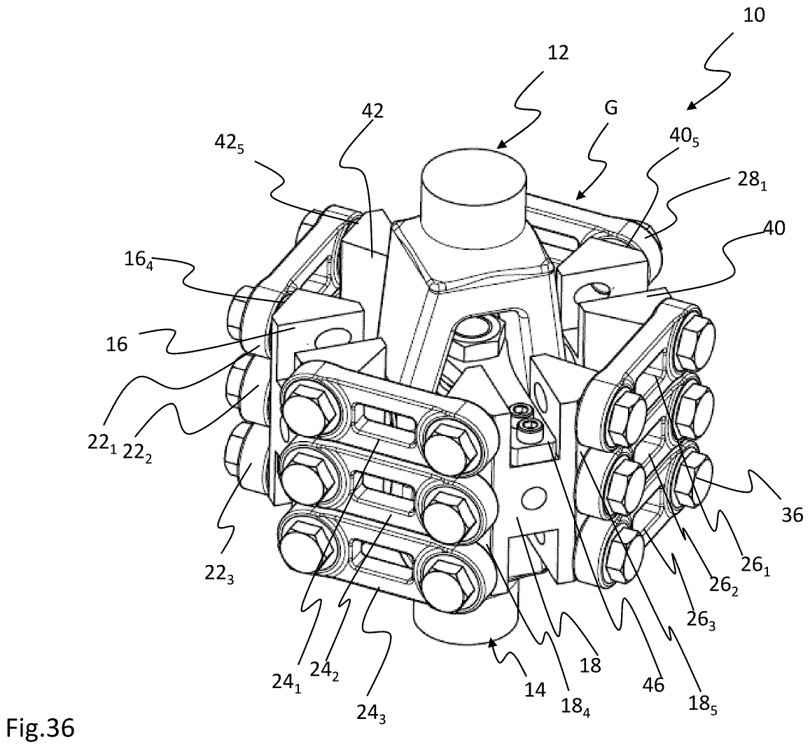

FIG. 36 shows a perspective view of a joint device 10 according to a further embodiment. The embodiment according to FIG. 36 is based on the embodiment described in FIGS. 33 to 35. The only essential difference between these two embodiments is that, according to FIG. 36, the coupling elements 22₁, 22₂, 22₃, 24₁, 24₂, 24₃, 26₁, 26₂, 26₃, 28₁ (the coupling elements 28₂ and 28₃ are not shown in FIG. 36) are provided on the fastening surfaces 16₄, 16₅, 18₄, 18₅, 40₄, 40₅, 42₄ and 42₅ offset in the axial direction from each other, wherein in FIG. 36, only the fastening surfaces 16₄, 18₄, 18₅, 40₅ and 42₅ are shown. On each fastening surface 16₄, 16₅, 18₄, 18₅, 40₄, 40₅, 42₄ and 42₅ of the bearing elements there are three coupling elements 22₁, 22₂, 22₃, 24₁, 24₂, 24₃, 26₁, 26₂, 26₃, 28₁ which are offset from each other in the axial direction and extend at least substantially parallel to each other.

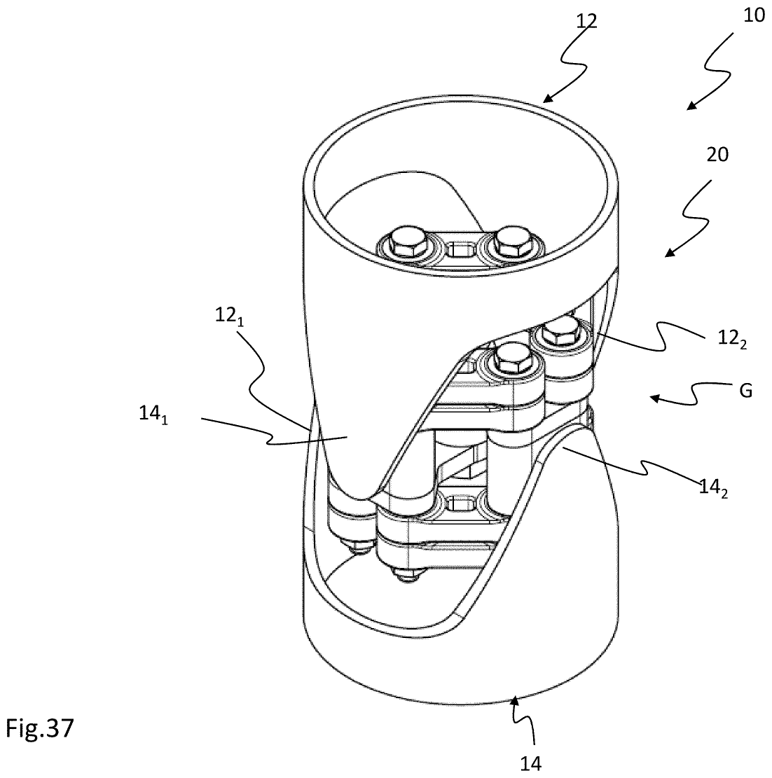

FIG. 37 shows a perspective view of a joint device 10 according to a further embodiment. According to FIG. 37, the joint forks 12 and 14 of the joint G are provided outside the damping arrangement 20. The joint forks 12 and 14 thus surround the damping arrangement 20 in the radial direction at least in sections. Each joint fork 12, 14 has two fork arms 12₁, 12₂, 14₁, 14₂ that engage in each other.

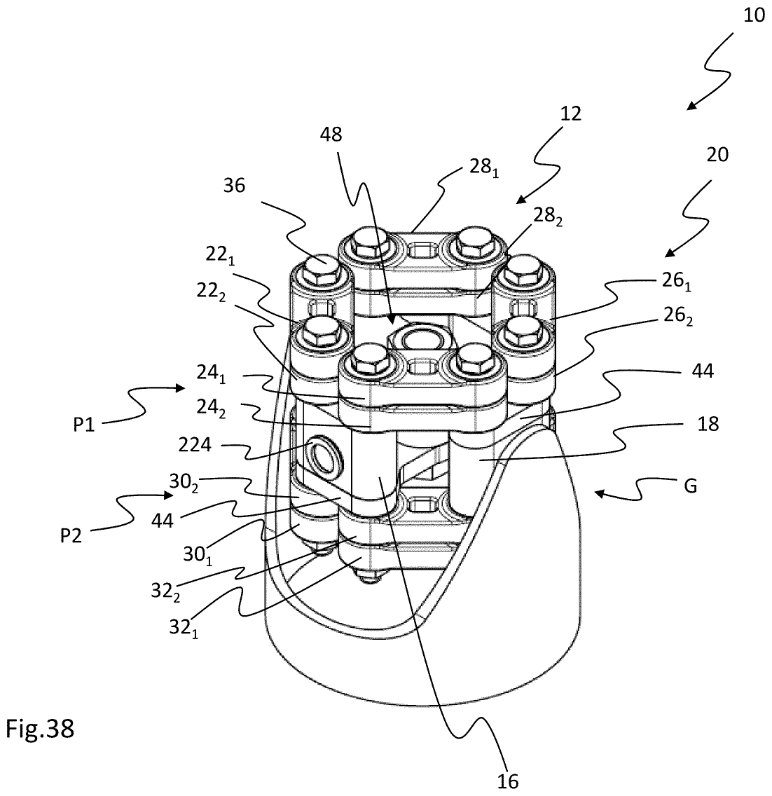

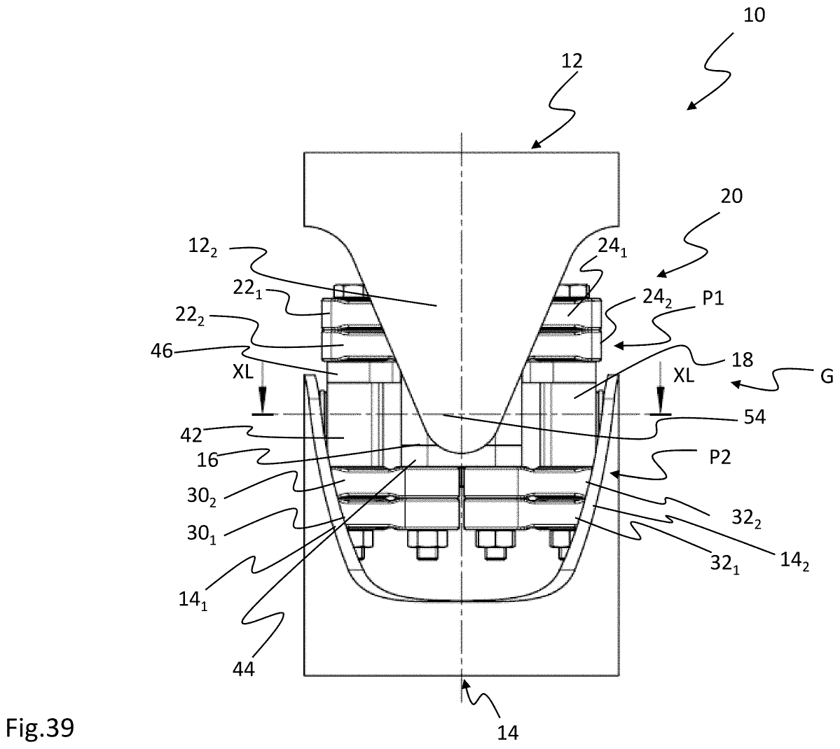

FIG. 38 shows a perspective view of the joint device 10, in which the joint fork 12 has been removed. It can be seen in FIG. 38 that the damping arrangement 20 and the bearing elements, of which only the bearing elements 16 and 18 are shown in FIG. 38, are constructed substantially as those described with reference to FIGS. 1 to 9 and 27 to 29. One of the essential differences can be seen in the bearing element 16. The bearing element 16 has a bearing 58 on a radially outer surface, into which a pivot pin (not shown) of the joint fork 12 (not shown) can engage from radially outside. The fork arms 14₁ and 14₂ are connected to the bearing elements 18 and 42. The fork arms 12₁ and 12₂ are connected to the bearing elements 16 and 40, only the bearing element 16 and the fork arm 12₁ being shown in FIG. 39.

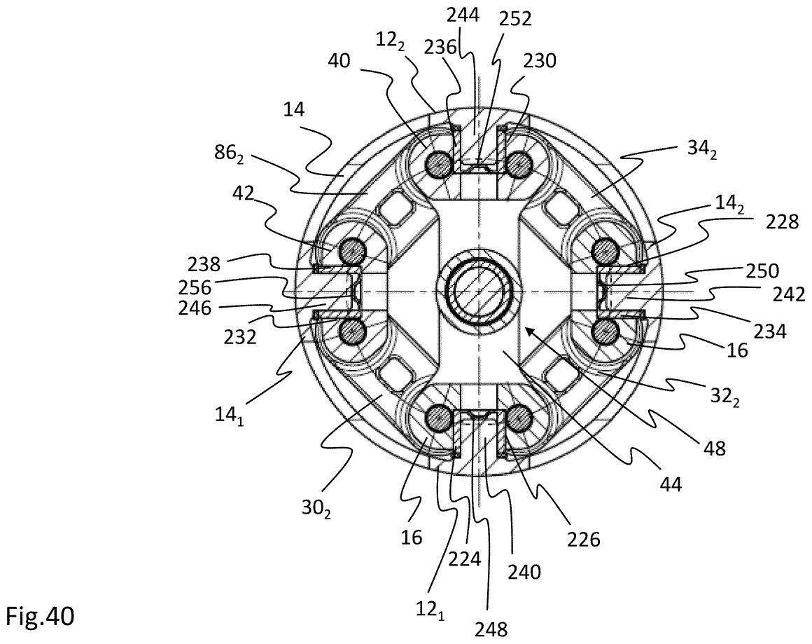

FIG. 40 shows a sectional view along the section line XL-XL in FIG. 39. The bearing elements 16, 18, 40, 42 each have an opening 226, 228, 230, 232 in which a bearing 224, 234, 236, 238 is accommodated. The bearings 224, 234, 236, 238 are inserted into the openings 226, 228, 230, 232 from radially outside. The pivot pins 240, 242, 244, 246 of the joint forks 12 and 14 are accommodated in the openings 226, 228, 230, 232 and extend from radially outside into the openings 226, 228, 230, 232. In the openings 226, 228, 230, 232 226, 228, 230, 232, plain bearings 248, 250, 252, 254 are also accommodated, on which the end faces of the pivot pins 240, 242, 244, 246 can be supported in the radial direction. The joint forks 12 and 14 extend at least in sections radially outside around the bearing elements 16, 18, 40, 42 and the damping arrangement 20. The shaft pins 240, 242, 244, 246 extend radially inward from the fork arms 12₁, 12₂, 14₁ and 14₂ into the openings 206, 228, 230, 232 and/or into the bearings 224, 234, 236, and 238.

FIG. 40 also shows the bracket 46 which connects the bearing elements 16 and 40 and the centering device 48. The centering device 48 has the features already described multiple times above. The centering device 48 can form a plain bearing that allows axial deflections between the joint forks 12 and 14.

At least the joint G and the damping arrangement 20 of the joint device 10 are arranged coinciding. The damping arrangement 20 can have several levels with coupling elements and/or damper parts. In the case of a damping arrangement with several levels, the damping arrangement is designed such that the levels of the damping arrangement together form a coinciding arrangement with the joint. The individual levels of the damping arrangement are not arranged coinciding with the joint G in this case.

1. A joint device for connecting two shaft sections, comprising:
at least one joint; and
at least one elastic damping arrangement which provides mechanical decoupling of the at least one joint and is coupled to the at least one joint in a torque transmitting manner, the elastic damping arrangement comprising at least one fiber package which is at least partially embedded in an elastic material, the at least one damping arrangement being coupled to the at least one joint in such a manner that at least the at least one joint and the at least one damping arrangement are arranged coincident at least in the rest state of the joint device.

2. The joint device according to claim 1, wherein the joint device has at least two devices at at least two positions offset in the axial direction which are designed to couple the at least one joint and the at least one damping arrangement.

3. The joint device according to claim 1, wherein the at least one damping arrangement has at least one damper part which has one or more fiber packages.

4. The joint device according to claim 3, wherein the at least one damper part has a plurality of coupling portions in each of which at least one fiber package is provided, wherein the coupling portions are connected to each other via at least one connecting portion.

5. The joint device according to claim 4, wherein the coupling portions have a plurality of fiber packages which extend at least substantially parallel and/or obliquely to each other.

6. The joint device according to claim 1, wherein the at least one damper part has a plurality of bushings, each of which is surrounded by two fiber packages.

7. The joint device according to claim 1, wherein the at least one damping arrangement has a plurality of elastic coupling elements, each of the coupling elements having at least one fiber package.

8. The joint device according to claim 1, wherein the at least one joint has at least two joint forks, the at least two joint forks being coupled to each other in a torque transmitting manner via the at least one damping arrangement.

9. The joint device according to claim 8, wherein each of the joint forks has at least two bearing elements, in each of which at least one bearing for mounting the joint forks is accommodated.

10. The joint device according to claim 9, wherein the bearing elements assigned to one of the joint forks are connected to each other via at least one bracket.

11. The joint device according to claim 10, wherein the brackets are coupled to each other so as to be rotatable relative to each other.

12. The joint device according to claim 9, wherein each of the bearing elements has at least one device which is designed to couple the at least one damping arrangement to the at least one joint.

13. The joint device according to claim 12, wherein the at least one device is at least one opening in one of the bearing elements and/or at least one projection at one of the bearing elements.

14. The joint device according to claim 1, wherein the at least one joint device has at least one coupling flange which couples the at least one damping arrangement to the at least one joint.

15. The joint device according to claim 14, wherein the at least one damping arrangement establishes a torque transmitting connection between the at least one coupling flange and at least one further flange.

16. The joint device according to claim 14, wherein at least the at least one coupling flange has at least two axial fastening surfaces which are offset from each other in the axial direction, wherein the at least two axial fastening surfaces being designed for coupling with the at least one damping arrangement.

17. The joint device according to claim 16, wherein at least one damper part of the at least one damping arrangement is arranged on each of the two axial fastening surfaces.

18. The joint device according to claim 1, wherein the at least one joint is a constant velocity joint.

19. The joint device according to claim 1, wherein the at least one joint device has at least one centering device which is arranged coincident with the at least one joint and the at least one damping arrangement.

20. The joint device according to claim 1, wherein the joint device is designed to provide a limit stop function.

21. The joint device according to claim 20, wherein each bearing element has at least one limit stop.

22. A damper part for a joint device according to claim 1, wherein the damper part has at least one coupling portion and at least one connecting portion, wherein in the at least one coupling portion at least one fiber package is provided which runs around two openings, and the at least one connecting portion is free of fiber reinforcement.
